(19) United States
(12) Patent Application Publication
(10) Pub. No.: US 2020/0151577 A1
(43) Pub. Date: May 14, 2020

(54) INTELLIGENT ENDPOINT SYSTEMS FOR MANAGING EXTREME DATA

(71) Applicant: FACET LABS, LLC, Los Gatos, CA (US)

(72) Inventors: Stuart OGAWA, Los Gatos, CA (US); Lindsay SPARKS, Seattle, WA (US); Koichi NISHIMURA, San Jose, CA (US); Wilfred P. SO, Mississauga (CA)

(21) Appl. No.: 16/627,420

(22) PCT Filed: Jun. 29, 2018
(86) PCT No.: PCT/US2018/040417

§ 371 Date: Dec. 30, 2019

Related U.S. Application Data
(60) Provisional application No. 62/528,014, filed on Jun. 30, 2017.
(60) Provisional application No. 62/540,499, filed on Aug. 2, 2017.

(51) Int. Cl. G06N 3/08; G06F 16/23; G06N 3/063; G06N 3/04

(52) U.S. Cl. CPC G06N 3/088; G06N 3/0454; G06N 3/063; G06F 16/2365

(57) ABSTRACT

A system and methods are provided that can make distributed and autonomous decision science based recommendations, decisions, and actions that increasingly become smarter and faster over time. The system can comprise intelligent computing devices and components (i.e., Intelligent Endpoint Systems) at the edge or endpoints of the network (e.g., user devices or IoT devices). Each of these Intelligent Endpoint Systems can optionally have the ability to transmit and receive new data or decision science, software, data, and metadata to other intelligent devices and third party components and devices so that data or decision science, whether real-time or near real-time, batch, or manual processing, can be updated and data or decision science driven queries, recommendations and autonomous actions can be broadcasted to other Intelligent Endpoint Systems and third party systems in real-time or near real-time.

### CROSS-REFERENCE TO RELATED APPLICATIONS:

This present patent application claims priority to U.S. Provisional Application No. 62/528,014 filed on Jun. 30, 2017 and titled “Intelligent Endpoint Systems For Managing Extreme Data” and

U.S. Provisional Application No. 62/540,499 filed on Aug. 2, 2017 and titled “Smart Distributed Systems For Managing Network Data”, the entire contents of which are herein incorporated by reference.

### BACKGROUND

The global proliferation and adoption of electronic devices has led to creation of more data than can be stored. Furthermore, data computation growth surpasses Moore's Law for global computation and the amount of data transmitted across networks and stored exceeds projected network bandwidth and data storage availability. In one recent analysis, 700 million users plus 20 billion Internet-of-Things (IoT) devices equated to approximately 4.5×10²³ interconnections among users and devices, a number which does not even include the actual data and the enriched metadata corresponding to the actual user-created data, machine data, and IoT data. Thus, 4.5×10²³, while a vast number, is only a portion of the data. We can refer to this type of data “Extreme” or “Explosive” Data (XD), which may refer to data that continues to exponentially grow and change.

Current computing environments send all XD to one or a few nodes or devices in order to make automated, intelligent decisions and/or autonomous actions. This approach is similar to conventional mainframe “hub and spoke”, batch data, or other similar traditional decision science processing framework or model. These conventional methods and techniques process/analyze XD by transmitting data from one point (i.e., the point of data creation) to other points across the network, and processing XD (e.g., capturing, indexing, storing, and graphing, to name a few steps) at that other points. This process can involve significant time delay, especially when dealing with XD and related content. Hence, meaningful real-time or near real-time data operations and decisions based on data are challenging—especially those that are based on application of machine learning and artificial intelligence—despite faster networks and computing technologies.

Furthermore, the aforementioned conventional approach requires transmitting or receiving XD and related metadata through various networks, which may require large computing resources and bandwidth. However, majority of such data is actually noise, wherein “noise”, in this context, may refer to duplicate data (e.g., “known known” data) or data that may be unnecessary or non-essential for performing relevant computation.

Time lag also increases exponentially since new data or decision science models are performed, for example, at the other node of the network 130. Moreover, once data/decision science is completed, the completed results need to travel back through the network and ultimately back to the user(s) or other end point (e.g., peripheral) devices, systems, and the like. Conventional methods, consequently, reinforce the extended user latency to perform data or decision science against inbound data and ultimately lengthens the time to receive, for example, real-time or near real-time business recommendations and actions.

### SUMMARY

In light of these problems, a different computing approach is suggested to analyze and recommend actions based on Extreme or Explosive Data (XD). In particular, “Intelligent Endpoint Systems” can be used to externalize and distribute data or decision science driven analysis to where data may be first created or obtained (e.g., by sensors on the Intelligent Endpoint Systems), and autonomously make decisions and take autonomous actions using onboard computing systems and devices.

An Intelligent Endpoint System (also herein interchangeably called an Endpoint System, Endpoint, Edge Node and IES) may be a system or device that can facilitate intelligent decisions, recommendations, make autonomous decisions, and take autonomous actions sooner and faster. Intelligent Endpoint Systems 102 may comprise XD processing resources, such that data collected or created by the Intelligent Endpoint Systems may be processed locally, onboard the device or across a collection of Intelligent Endpoint Systems. In particular, such an approach, as disclosed herein, can be used to provide a technical solution that can efficiently make distributed, decision science based recommendations and actions and provide increasingly smarter recommendations and actions over time. For example, currently available methods of creating and uploading XD to the public cloud for analysis may require extensive amount of time and networking bandwidth. Consequently, many business entities or individuals may opt to delete a large portion of the XD due to high operational costs and inefficiencies. This can adversely impact the ability to train systems and/or devices for deep learning/machine learning applications, since XD can be too expensive to store and/or transmit.

The systems and related methods disclosed herein can be used to facilitate intelligent decision making at, or by, the Intelligent Endpoint Systems, which can enable the efficient and timely application of machine learning, deep learning, and other related artificial intelligence techniques.

Intelligent Endpoint Systems may also help efficiently distribute computing resources and network bandwidth. The approach disclosed herein may involve performing data analysis and applying decision science at Intelligent Endpoint Systems or through a distributed network of Intelligent Endpoint Systems, for data/information that is necessary, valuable, or important for the specific application, device, system, etc. For example, Intelligent Endpoint Systems may be configured to detect/determine “known known” data, and such data may be discarded before being transmitted across the network for additional analysis, saving network bandwidth resources.

The Intelligent Endpoint Systems and related methods comprise a computer platform and relevant computer components, that can individually or collectively make distributed and autonomous decision science based recommendations/actions that can increasingly become smarter and faster (e.g., improvement through machine learning) over time.

The Intelligent Endpoint Systems may involve sensing, monitoring, learning, analyzing, and taking actions in order to attain “perfect information” or near-perfect information of devices and systems within a given environment or region, and make timely technical or business decisions. If one attempted sensing, monitoring, analyzing, learning, and taking autonomous actions on all of this aforementioned data using the current systems and methods, all computing and network resources and time would be spent ingesting (e.g., receiving information that is transmitted)—by a backend server or centralized computer systems—and indexing the information. The time lag between ingesting and indexing information relative to actually performing data/decision science and take preemptive actions would increase dramatically, and render the current systems and methods, ultimately useless or inefficient to use for real-time or near real-time applications.

Furthermore, the Intelligent Endpoint Systems and related methods can be configured to apply, for example, a sliding scale 80/20 decision making allocation, whereby 80% of the intelligent decisions and actions can be distributed away to the Intelligent Endpoint Systems (e.g., to other peripheral or IoT devices) from a central computing platform (e.g., public cloud platform). The sliding scale decision making allocations can be made by people, data science (e.g. artificial intelligence, machine learning, algorithms, fuzzy logic or any combination of the aforementioned), or a hybrid approach using both people and data science. Over time, the decisions and actions can, be gradually distributed closer to where the data originated, sensed, or created, which is where the Intelligent Endpoint System may be located to capture or create such data.

Where and how intelligent endpoint data processing executes can occur different ways. One IES strategy is where data creation or generation first occurs. For example, an IoT device that performs a measurement or captures data (e.g. temperature, humidity, voltage, width, location, heart rate, brain signal, radio signal, image capture, etc.) defines first point of data creation or generation. The IoT sensor device that captures, creates, generates, and detects the anomaly, or any combination of the aforementioned exemplifies the IES first data creation or generation point strategy.

The Intelligent Endpoint Systems and related method “extends intelligence” (e.g., by equipping, embedding, applying, installing, updating, etc. data or decision science capabilities) to all electronic devices at the end point or periphery of the network, including but not limited to computers, smart phones, wearable devices, prosthetic limbs, brain-computer interfaces, human-computer interfaces, TVs, appliances, electronically controlled machines and processing equipment, other electronic devices or IoT devices, robotic devices, sensors in manufacturing applications, sensors in material handling applications, sensors in food and drug applications, sensors in environmental monitoring, drones, vehicles including those with and without self-driving capability, aircraft, marine craft, satellites, small satellites, cubesats, medical devices, blockchain-integrated devices, devices incorporating audio and multimedia projector functions, holographic projector devices, and various components included in the respective devices.

In an example embodiment, an Intelligent Endpoint System is very small, such as approximately one or a few millimeters in size. For example, an Intelligent Endpoint System has dimensions of approximately 5 mm×5 mm or less. In another example, an Intelligent Endpoint System is approximately 1 mm×1 mm. In another example embodiment, an Intelligent Endpoint System is a micro-sized device. In another example embodiment, an Intelligent Endpoint System is a nano-sized device. Such devices may also include any other peripheral computing devices.

The Intelligent Endpoint Systems are also equipped with one or more processors that execute machine learning and data science computations. For example, central processing units (CPUs), Graphics Processing Units (GPUs), neuromorphic chips, Field Programmable Gate Arrays (FPGAs), Tensor Processing Units (TPUs), ASICs, System on Chips (SOCs), amongst others, are examples of hardware processors that are incorporated into the Intelligent Endpoints Systems and that execute machine learning computations or data science computations or other types of computations. These onboard processors, which are used for a variety of floating point intensive math calculations, can enable software developers to perform localized processing (e.g. facial recognition, text recognition, image recognition, voice recognition, speech recognition, predictions, etc.) as opposed to sending data to a centralized computing platform to analyze the data. This exemplifies moving intelligence and actions closer to the point/location where data can initially be sensed and/or created.

Additionally, Intelligent Endpoint Systems and related methods as disclosed herein can enable varying degrees of autonomous intelligence and actions. Attempting to ingest and make timely decisions based upon trillions of computing device and component network data can be a futile effort. Instead, the Intelligent Endpoint Systems and related methods can provide “governance intelligence”, which may refer to master databases (either distributed or centralized) comprising for example, business or technical policies, guidelines, rules, metrics, and actions. Such governance intelligence can enable sets and subsets of Intelligent Endpoint Systems and their components to make distributed and localized decisions and actions that support the overarching global and nominal policies, guidelines, rules, actions specified by the “governance” intelligence.

Furthermore, digital electronic components, or analog electronic components or analog hardware (e.g. mechanical hardware, chemical devices, etc.) connected to or equipped with digital computing components, or both, that make up the aforementioned devices such as power supplies, microprocessors, RAM, disk drives, resistors, relays, capacitors, diodes, and LED screens, can also be equipped with computing intelligence. In the context of analog devices, such as a power transformer, has a built in current sensor or temperature sensor that provides sensor data (e.g. local data) to a processor with computing intelligence; the collective of these devices forms an Intelligent Endpoint System. In the context of a digital electronic components, the number of read and write actions (e.g. local data) are counted in a RAM device or a cache device in a chip, which provides an indication of the wear or remaining lifespan of the device, and this local data is processed by a processor with computing intelligence; the collection of these devices form an Intelligent Endpoint System. Computing intelligence may require a combination of various components, databases, storage, immutable ledgers, blockchains, ledgerless blockchains, and systems, wherein data or decision science capabilities can be embedded or installed. Self-stacking nano-technology can potentially facilitate designing and manufacturing intelligent components previously limited to only processor-like devices (CPUs, GPUs, TPUs, FPGAs, etc.). This nanotechnology can further support the 80/20 decision making allocation for distributed intelligent decisions and actions by enabling these previously unintelligent or “dumb” electronic devices to, for example, self-monitor, run self-diagnostics, and communicate status information before the part itself may become subject to failure. Alternatively, this same intelligence running on previously dumb devices can inevitably lead to a whole new level of in-circuit and embedded sensors as more and more devices and components move into nanotechnology. In other words, according to an example embodiment, a nanotechnology device or system is an Intelligent Endpoint System.

These and other example embodiments are described in further detail in the following description related to the appended drawing figures.

### BRIEF DESCRIPTION OF THE DRAWINGS

Embodiments will now be described by way of example only with reference to the appended drawings wherein:

FIG. 1 shows an environment in which the Intelligent Endpoint Systems may operate according to an example embodiment;

FIG. 2 shows components of an Intelligent Endpoint System, according to some example embodiments;

FIG. 3A shows a flowchart of computer executable or processor implemented instructions for managing XD according to an example embodiment;

FIG. 3B shows a flowchart of computer executable or processor implemented instructions for evaluating XD according to an example embodiment;

FIG. 3C shows a flowchart of computer executable or processor implemented instructions for querying other Intelligent Endpoint Systems according to an example embodiment;

FIG. 4 shows a flowchart of computer executable or processor implemented instructions for another method for managing XD according to an example embodiment;

FIG. 5 shows a flowchart of computer executable or processor implemented instructions for updating an Intelligent Endpoint Systems, according to an example embodiment;

FIGS. 6A and 6B shows groupings of Intelligent Endpoint Systems that are grouped by regions and that are in communication with one or more centralized computing systems, according to different example embodiments;

FIGS. 7A and 7B show flowcharts of computer executable or processor implemented instructions for transmitting data between different groupings of Intelligent Endpoint Systems, according to different example embodiments;

FIG. 8A shows a flowchart of computer executable or processor implemented instructions for a given Intelligent Endpoint System performing a check with neighboring Intelligent Endpoint Systems in relation to an anomaly, according to an example embodiment;

FIG. 8B shows a flowchart of computer executable or processor implemented instructions for a given Intelligent Endpoint System detecting an anomaly while neighboring Intelligent Endpoint Systems detect no anomaly, according to an example embodiment;

FIG. 9 shows an example embodiment of Intelligent Endpoint Systems moving between locations;

FIG. 10A shows a schematic diagram of a given Intelligent Endpoint System propagating updates to other Intelligent Endpoint Systems, and a related flowchart of computer executable or processor implemented instructions, according to an example embodiment;

FIG. 10B shows a schematic diagram of a given Intelligent Endpoint System propagating updates to other Intelligent Endpoint Systems, and a related flowchart of computer executable or processor implemented instructions, according to another example embodiment;

FIG. 11 shows a schematic diagram and a related flowchart of computer executable or processor implemented instructions for multiple existing Intelligent Endpoint Systems seeding a new Intelligent Endpoint System in order to provision the new Intelligent Endpoint System, according to an example embodiment;

FIG. 12 shows a schematic diagram of a distributed database and processing architecture for multiple Intelligent Endpoint Systems, according to an example embodiment; and

FIG. 13 shows a schematic diagram of an architecture of multiple Intelligent Endpoint Systems that are coordinated to form a generative adversarial network, according to an example embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

A method and a system are provided that can analyze and recommend solutions based on Extreme or Explosive Data (XD). XD, as used herein, may generally refer to data that is vast, increasing in size at an increasing rate, and/or changing over time, usage, location, etc. The method and system as disclosed herein can make distributed, data or decision science based recommendations and actions and can make increasingly smarter recommendations and actions over time.

A system and a method are provided that can apply data or decision science to perform autonomous decisions and/or actions across computing systems and devices. Data science or decision science may refer to math and science applied to data including but not limited to algorithms, machine learning, artificial intelligence science, neutral networks, and any other math and science applied to data. The results from data or decision science include, but are not limited to, business and technical trends, recommendations, actions, and other trends. Data or decision science includes but is not limited to individual and combinations of algorithms (may also be referred to herein as “algos”), machine learning (ML), and artificial intelligence (Al), to name a few. This data or decision science can be embedded, for example, as microcode executing inside of processors (e.g. CPUs, GPUs, FPGAs, TPUs, ASICs, neuromorphic chips), scripts and executables running in operating systems, applications, subsystems, and any combinations of the aforementioned. Additionally, this data or decision science can run as small “micro decision science” software residing in static and dynamic RAM memory, cache, EPROMs, solid state and spinning disk storage, and aforementioned systems that span a number of Endpoints with the aforementioned memory types and with different types of memory. A method for applying data and decision science to evaluate data can include, for example, Surface, Trend, Recommend, Infer, Predict and Action (STRIPA) data or decision science. Categories corresponding to the STRIPA methodology can be used to classify specific types of data or decision science to related classes, including for example Surface algorithms (“algos”), Trend algos, Recommend algos, Infer algos, Predict algos, and Action algos. Surface algos, as used herein, may generally refer to data science that autonomously highlights anomalies and/or early new trends. Trend algos, as used herein, may generally refer to data science that autonomously performs aggregation analysis or related analysis. Recommend algos, as used herein, may generally refer to data science that autonomously combines data, meta data, and results from other data science in order to make a specific autonomous recommendation and/or take autonomous actions for a system, user, and/or application. Infer algos, as used herein, may generally refer to data science that autonomously combines data, meta data, and results from other data science in order to characterize a person, place, object, event, time, etc. Predict algos, as used herein, may generally refer to data science that autonomously combines data, meta data, and results from other data science in order to forecast and predict a person, place, object, event, time, and/or possible outcome, etc. Action algos, as used herein, may generally refer to data science that autonomously combines data, meta data, and results from other data science in order to initiate and execute an autonomous decision and/or action.

Data or decision science examples may include, but are not limited to: Word2vec Representation Learning; Sentiment multi-modal, aspect, contextual; Negation cue, scope detection; Topic classification; TF-IDF Feature Vector; Entity Extraction; Document summary; Pagerank; Modularity; Induced subgraph; Bi-graph propagation; Label propagation for inference; Breadth First Search; Eigen-centrality, in/out-degree; Monte Carlo Markov Chain (MCMC) sim. on GPU; Neural Networks; Deep Learning with R-CNN; Generative Adversarial Networks; Torch, Caffe, Torch on GPU; Logo detection; ImageNet, GoogleNet object detection; SIFT, SegNet Regions of interest; Sequence Learning for combined NLP & Image; K-means, Hierarchical Clustering; Decision Trees; Linear, Logistic regression; Affinity Association rules; Naive Bayes; Support Vector Machine (SVM); Trend time series; Fuzzy Logic; Burst anomaly detect; KNN classifier; Language Detection; Surface contextual Sentiment, Trend, Recommendation; Emerging Trends; Whats Unique Finder; Real-time event Trends; Trend Insights; Related Query Suggestions; Entity Relationship Graph of Users, products, brands, companies; Entity Inference: Geo, Age, Gender, Demog, etc.; Topic classification; Aspect based NLP (Word2Vec, NLP query, etc); Analytics and reporting; Video & audio recognition; Intent prediction; Optimal path to result; Attribution based optimization; Search and finding; and Network based optimization.

An Intelligent Endpoint System can have the ability to transmit to and/or receive from one or more other Intelligent Endpoint Systems, new data or decision science, software, data, and metadata. Consequently, data or decision science can be updated and data or decision science driven queries, recommendations and autonomous actions can be broadcasted to other Intelligent Endpoint Systems and third party systems in real-time or near real-time.

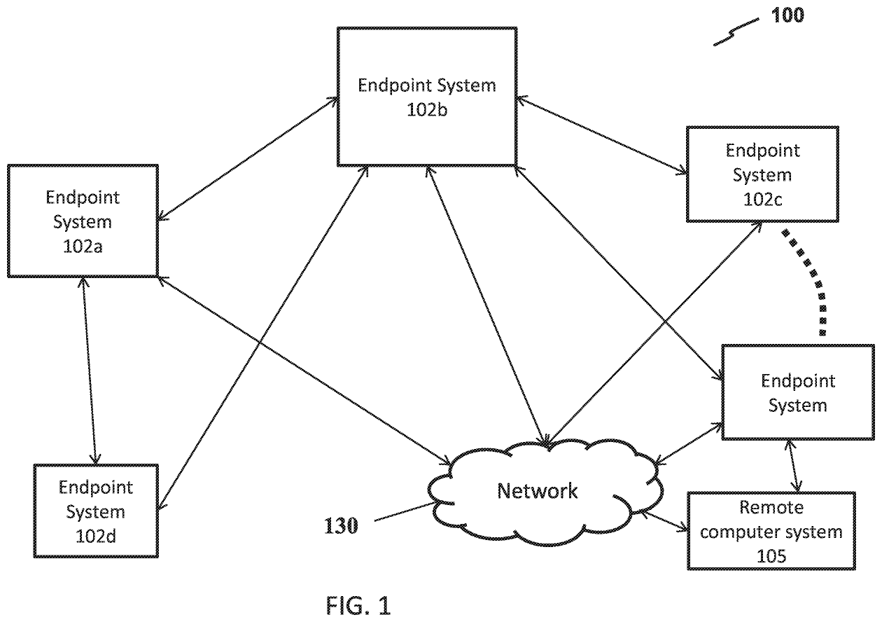

FIG. 1 shows an environment comprising various types of Intelligent Endpoint Systems represented by different sized boxes, according to an embodiment described herein. The computing environment 100 may comprise a plurality of Intelligent Endpoint Systems and networks. The various Intelligent Endpoint Systems can be dispersed throughout the computing environment 100. Similar to a human brain with neurons and synapses, neurons can be considered akin to Intelligent Endpoint Systems and synapses can be considered akin to networks. Hence, Intelligent Endpoint Systems are distributed and consequently support the notion of distributed decision making—an important example aspect in performing XD decision science resulting in recommendations and actions.

Intelligent Endpoint Systems can comprise various types of computing devices or components such as processors, memory devices, storage devices, sensors, or other devices having at least one of these as a component. Intelligent Endpoint Systems can have any combination of these as components. Each of the aforementioned components within a computing device may or may not have data or decision science embedded in the hardware, such as microcode data or decision science running in a GPU, data or decision science running within the operating system and applications, and data or decision science running as software complimenting the hardware and software computing device.

As shown in FIG. 1, a computing environment 100 can comprise various Intelligent Endpoint Systems 102a, 102b, 102c, 102d (also collectively referred to herein as 102) and a network 130. One Intelligent Endpoint System can interact or communicate with any other Intelligent Endpoint Systems via a network 130 or via direct communication between any one of the Intelligent Endpoint Systems (e.g., peer-to-peer networking). In an example aspect, the Intelligent Endpoint Systems directly communicate with each other via wireless communication (e.g. radio waves, light signals, other radiation signals, etc.). In another example, either in addition or in the alternative, the Intelligent Endpoint Systems communicate with each other via the network 130.

The Intelligent Endpoint Systems 102 may be configured to collect, obtain, or create local data, wherein the local data may include sensor data or other machine generated data, for example. The Endpoint Systems may be further configured to process such collected or generated data, wherein the data processing may include application of data or decision science algorithms, machine learning algorithms, or other algorithms necessary for the analysis of the collected or generated data. The Intelligent Endpoint Systems may also query and collect data from other Endpoint Systems, enterprise systems, and third party systems in order to help make localized decisions.

The Intelligent Endpoint Systems 102 may include, but not limited to any peripheral computing devices or IoT devices, or general computing devices configured to collect, obtain, and/or process data. For example, peripheral computing devices may include cellular telephone, personal digital assistant (PDAs), a tablet, a desktop or a laptop computer, a wearable device, or any other devices including computing functionality and data communication capabilities. Intelligent Endpoint Systems may also comprise one or more IoT devices, configured to perform the methods and processes disclosed herein. As shown in FIG. 1, the Intelligent Endpoint System 102a and Endpoint System 102b may be a different system or device. Other examples of Intelligent Endpoint Systems are described in the Summary section and in other examples below.

In some embodiments, the Intelligent Endpoint Systems 102 may include, but not limited to, for example, “Algo Flashable” Microcamera with WiFi Circuit, wherein “algo flashable” may refer to Intelligent Endpoint Systems which can be configured to have algorithms (e.g., data or decision science related algorithms) installed, removed, embedded, updated, or loaded.

Each Intelligent Endpoint System 102 can perform general or specific types of data or decision science, as well as perform varying levels (e.g., complexity level) of computing capability (data or decision science compute, store, etc.). For example, Algo Flashable Sensors with a WiFi circuit perform more complex data science algorithms compared to those of Algo Flashable Resistor and Transistor with a WiFi circuit, or vice versa. The complexity level may be dependent upon the capability of the Intelligent Endpoint system 102, for example, the onboard computing capability, features, and functionality.

The network 130 can comprise one or more combinations of both wired and wireless networks. The network 130 may be a communication pathway between any two Intelligent Endpoint Systems 102, or a communication pathway between an Intelligent Endpoint Systems and any other communication or computation devices, including sever systems and databases. The network 130 may comprise any combination of local area and/or wide area networks using both wireless and/or wired communication systems. For example, the network 130 may include the Internet, as well as mobile telephone networks. In one embodiment, the network 130 uses standard communications technologies and/or protocols. Hence, the network 130 may include links using technologies such as Ethernet, 802.11, worldwide interoperability for microwave access (WiMAX), 2G/3G/4G mobile communications protocols, asynchronous transfer mode (ATM), InfiniBand, PCI Express Advanced Switching, etc. Other networking protocols used on the network 130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. In an example embodiment, the network includes satellite communication. In another example embodiment, the network facilitates machine-to-machine communication enabled by one or multiple satellites (e.g. a constellation of satellites). In another example embodiment, the network facilitates machine-to-machine communication through other machines in the network.

In an example embodiment, a remote computer system 105 communicates with one or more of the Intelligent Endpoint Systems 102 via the network 130 or through peer-to-peer communication. The remote compute system 105 can utilize the collective computing power of the Intelligent Endpoint Systems.

In an example embodiment, a system is provided for managing vast amounts of data to provide distributed and autonomous decision based actions on Intelligent Endpoint Systems. The system includes a remote computer system 105 that requests local data from one or more Intelligent Endpoint Systems 130. The Intelligent Endpoint System(s) is or are among the plurality of Intelligent Endpoint Systems connected to the network 130. The one or more Intelligent Endpoint Systems are inserted, dispensed, positioned, activated or provisioned at a point where the requested local data is first created or obtained, wherein the plurality of Intelligent Endpoint Systems are configured to perform localized data science related to the local data, prior to transmitting the requested local data to the remote computer system.

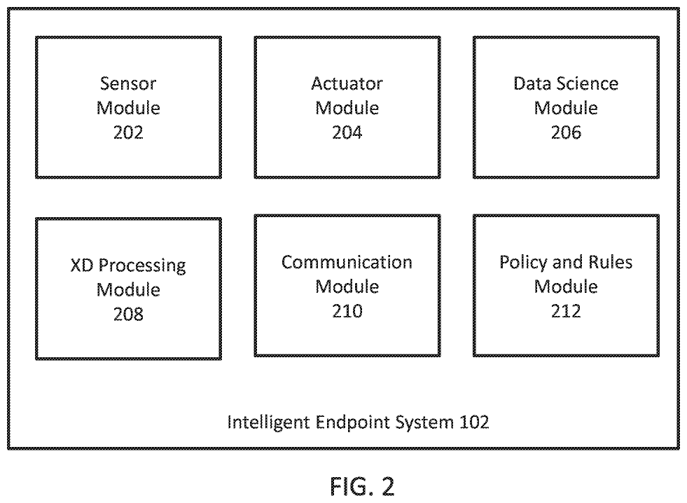

FIG. 2 shows components of an Intelligent Endpoint System 102, according to some embodiments described herein. The Intelligent Endpoint System includes a sensor module 202, an actuator module 204, a data science module 206, an XD processing module 208, a communication module 210, and a policy and rules module 212.

These components of the Intelligent Endpoint System 102 are functional components that can generate useful data or other output using specific input(s), or may include or be connected to storage or databases. The components can be implemented as general or specific-purpose hardware, software, firmware (or any combination thereof) components. A component may or may not be self-contained. Depending upon implementation-specific or other considerations, the components may be centralized or distributed functionally or physically. Although a particular number of components are shown in FIG. 2, the Intelligent Endpoint System 102 can include more components or can combine the components into fewer components (such as a single component), as may be desirable for a particular implementation. One or more of the components can be implemented across multiple distinct Intelligent Endpoint Systems. The interactions among these components are illustrated in detail below.

The sensor module 202 includes one or more sensor and related systems. Some examples of sensors as parts of the sensor module may include, but not limited to location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, LiDAR, time-of-flight or depth cameras), inertial sensors (e.g., accelerometers, gyroscopes, and/or gravity detection sensors), altitude sensors, attitude sensors (e.g., compasses), pressure sensors (e.g., including but not limited to barometers), temperature sensors, humidity sensors, vibration sensors, seismic sensors, biometric sensors, brain signal sensors, nerve-signal sensors, muscle-signal sensors, strain gauge sensors, chemical sensors, biochemical sensors, audio sensors (e.g., microphones), and/or field sensors (e.g., magnetometers, electromagnetic sensors, radio sensors). The sensor module 202 may also include one or more processing devices/systems to initially process the obtained data.

In an example aspect, the actuator module 204 includes one or more components configured to move or control the Intelligent Endpoint System. In another example aspect, the actuator module 204 is a component that physically affects a thing or an environment around the Intelligent Endpoint System. The actuator module includes one or more actuators. The actuators include, for example, one or more of hydraulic, pneumatic, electric, thermal, photonic, and mechanical actuators. The actuator module 204 may include software components to configure one or more aspects of the aforementioned actuators or any combination of the above.

The data science module 206, for example, is configured to provide data or decision science algorithms and/or toolboxes and related functionalities to the Intelligent Endpoint System 102. The data science module 206 interacts with the XD processing module 208 to aid in the processing of XD. For example, the data science module 206 may store one or more data science algorithms accessible by one or more other modules of the Intelligent Endpoint System 102, including the XD processing module 208. The data science module 206 may also interact with the communication module 210 and may be configured to be updated via the network 130 or any other communication methods. The data science module 206 may also interact with the policy and rules module 212 in order to update or configure the policy and rules stored in the module, for example. The data science module 206 may be associated with one or more storages or databases, the data science algorithms and/or toolboxes stored in such storages or databases may be updated via the network 130.

The communication module 210 may be configured to provide various types of communication functionalities to the Intelligent Endpoint System. The communication module 210 may be configured to provide communication with the network 130. The communication module 210 may be configured to provide Intelligent Endpoint Systems peer-to-peer or direct communication capabilities with other Intelligent Endpoint Systems. For example, each Intelligent Endpoint System 102 can be configured to automatically and autonomously query other Intelligent Endpoint Systems in order to better analyze information and/or apply recommendations and actions based upon, or in concert with, one or more other Intelligent Endpoint Systems and/or third party systems. For example, third-party systems may be any systems which may benefit from interacting or being in communication with the Intelligent Endpoint Systems. Third-party system examples include, but not limited to systems and databases associated with ComScore, FICO, National Vulnerability Database, Center for Disease Control and Prevention, U.S. Food and Drug Administration, and World Health Organization, and the like.

The XD processing module 208 may be configured to process XD. For example, each Intelligent Endpoint System 102 can optionally have an ability to reduce “noise” and in particular, to reduce XD that is “known known” data or data that may be duplicative. “Known known” data can be in the form of both known data as well as, but not limited to preexisting known answers, recommendations, patterns, classifications, predictions, trends, or other data that is already known or adds no new information.

Alternatively or additionally, “known known” data may be determined by establishing a “reference data set” (i.e., a master dataset or master database), which may contain one or more answers, recommendations, trends, or other data or metadata. As such, “known known” data or metadata may be any data that, when compared to the “reference data set”, is determined to be a duplicate or an unnecessary data set for the computation at hand. Such “reference data set” may be stored as part of the XD processing module 208 or may be separate from the XD processing module 208. In an example aspect, if the data is identical or is within a certain tolerance level or meets certain business rule conditions, conditions, data science driven and or re-calculable data and or answers, or other pre-defined nominal state, then the Intelligent Endpoint System decides not to transmit, store, compute such duplicative data, and/or include such duplicative data as part of the computation.

In some embodiments, an Intelligent Endpoint System can apply, for example, System on Chip (SOC) or DSP-like filters to analyze and discard duplicative or duplicative-like data (e.g., “known known” data) throughout a computing environment 100, thereby eliminating the need to transmit or process such data in the first place. The XD processing module 208 may be configured to execute the aforementioned process. This method can, for example, reduce network traffic, improve computing utilization, and ultimately facilitate the application of efficient real-time/near real-time data or decision science with autonomous decisions and actions. This reduction of XD, especially at the local level or through a distributed computing environment 100 may provide a system comprising Intelligent Endpoint Systems 102 the ability to identify eminent trends and to make preemptive business and technical recommendations and actions faster, especially since less duplicative data or XD allows for faster identification and recommendations. The tolerance level mentioned above may be configured by one or more Intelligent Endpoint Systems 102 based on the type of computation involved, in order to optimize the computational efficiency.

Alternatively or additionally, the SOC, for example, can make localized decisions on the Intelligent Endpoint System 102 using the sensors, onboard computing resources which contain localized data science, onboard SOC storage used as a local reference data set, as described above. Such configuration can enable fact local decision making and action.

The XD processing module 208 may be configured to provide each Intelligent Endpoint System with data or decision science software including but not limited to operating systems, applications, and databases, which directly support the data or decision science driven Intelligent Endpoint System 102 actions. For example, Linux, Android, MySQL, Hive, and Titan or other software could reside on each Intelligent Endpoint Systems so that the local data or decision science can query local, on device, related data to make faster recommendations and actions. In another example, applications such as Oracle and SAP can be queried by the XD processing module 208 in order to reference financial information, manufacturing information, and logistics information, wherein such information may aid the system in providing improved data science decision(s) and execute the best action(s).

The policy and rules module 212 may be configured to provide data or information on policies and rules governing the Intelligent Endpoint Systems 102. The policy and rules module 212 may be configured to provide information or data on, for example, governing policies, guidelines, business rules, nominal operating states, anomaly states, responses, KPI metrics, and other policies and rules. The distributed network of Intelligent Endpoint Systems 102 may be configured to rely on such policies and rules to make local and informed autonomous actions based on the collected set of data. A number (e.g., NIPRS) of policy and rules modules can exist, and each module 210 can have either identical or differing policies or rules amongst themselves or alternatively can have varying degrees or subsets of policies and rules. Multiple sets of policy and rules may exist for each policy and rules module 212. This latter alternative is important when there are localized business and technical conditions that may not be appropriate for other domains or geographic regions, and/or different manufacturing facilities, laboratories, to name a few.

Each Intelligent Endpoint System can also be configured to predict and determine which network or networks, wired or wireless, are optimal for communicating information based upon local and global parameters including but not limited to business rules, technical metrics, network traffic conditions, proposed network volume and content, and priority/severity levels, to name a few.

In some embodiments, an Intelligent Endpoint System 102 can optionally select a multitude of different network methods to send and receive information, either in serial or in parallel. An Intelligent Endpoint System can optionally determine that latency in certain networks are too long or that a certain network has been compromised, for example, by providing or implementing security protocols, and can be configured to reroute content using different encryption methods and/or reroute to different networks. An Intelligent Endpoint System 102 can optionally define a path via for example nodes and networks for its content.

Systematic Walkthrough of Intelligent Endpoint Systems

For clarity of presentation, rather than sending all the XD through the network 130, the Intelligent Endpoint Systems 102 and related methods are exemplified and described with a focus on solving the aforementioned XD situation by decomposing this situation into two basic phases. In some embodiments, the XD processing module 208 may be configured to execute the below methods. The two phases described herein are described as an example and the operation of the Intelligent Endpoint System 102 and the XD processing module 208 may involve additional phases.

Phase 1:

Intelligent Endpoint System Configuration

As shown in FIG. 1, a computing environment 100 can comprise Intelligent Endpoint Systems 102 that can create local data and can perform localized data or decision science related to the local data. Thus, in a first phase or phase one (1) of a method for managing XD, an Intelligent Endpoint System can be configured to create local data and to perform localized data or decision science related to the local data. In particular, Intelligent Endpoint Systems can be provisioned for example, with localized data or decision science (e.g. algos, ML, Al, and other data or decision science) using localized processors including but not limited to CPUs, GPUs, FPGAs, ASICs and other localized processors as known in the art or yet to be developed.

To perform localized data or decision science related to the local data, Intelligent Endpoint Systems can execute the localized decision science: within a processor such as for example, microcode running inside of a CPU(s), GPU(s), FPGA(s), ASIC(s); by executing code in RAM, EEPROM, solid state disks, rotational disks, cloud based storage systems, storage arrays; by executing code spanning a number of Intelligent Endpoint Systems and a number of the aforementioned processor, memory, and store combinations.

Data Processing

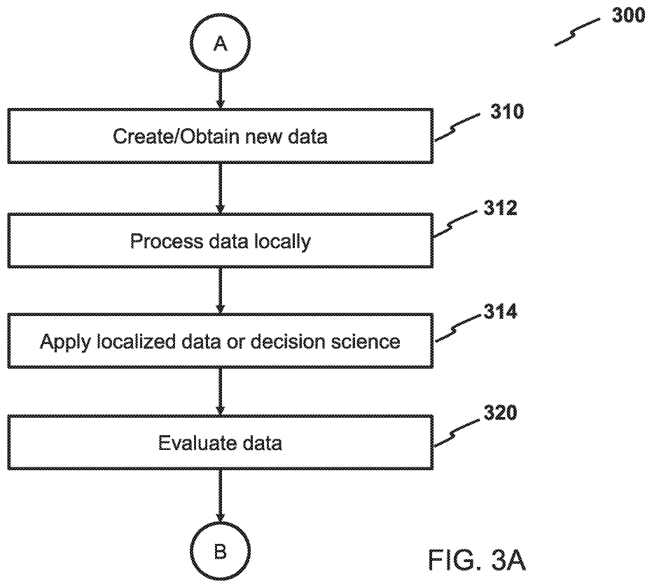

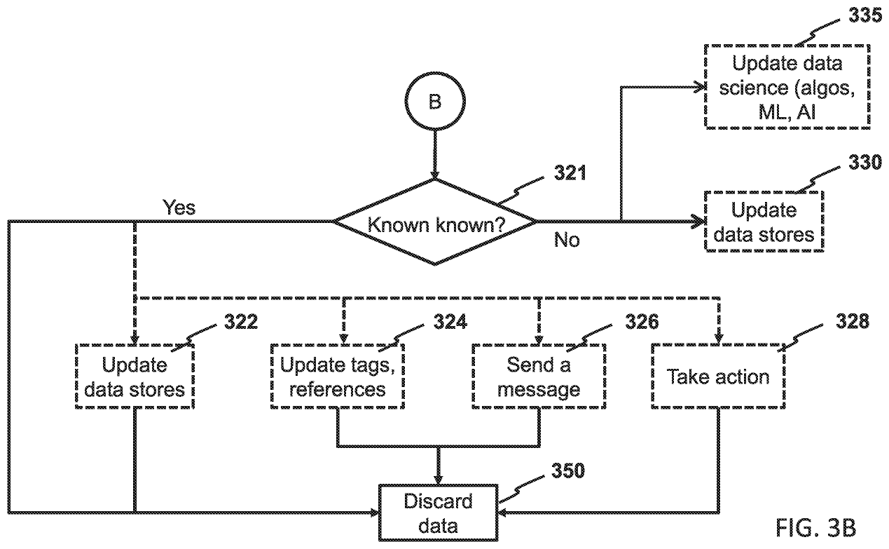

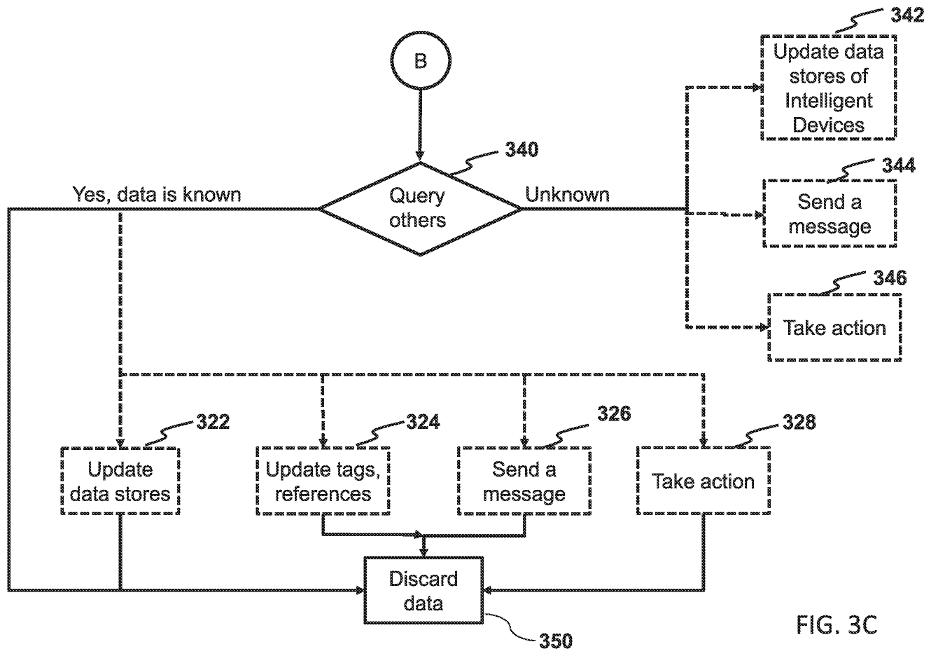

FIG. 3A shows a flowchart for a data processing method 300 for managing XD, according to an embodiment described herein. In some embodiments, the XD processing module 208 may be configured to execute the data processing method described below. First, an Intelligent Endpoint System can begin at 310 by creating or obtaining new data (e.g. machine data, system logs, user generated related data, meta data, multimedia data and meta data, sensor and IoT related data, or any other form of new data). As the data is locally generated, the data can immediately be fed at 312 directly (as opposed to transmitting directly to other devices/nodes in the network) into the Intelligent Endpoint System's local processors, RAM, memory or other local components or any other combination thereof, in real-time or batch mode or any combination of both real-time and batch mode for local processing. As the data is fed into the local components (e.g. processors, memory, and/or disk), the localized data or decision science, running on this Intelligent Endpoint System 102, can be applied at 314 to this local data. Localized XD data processing can be distinguished from transmitting XD to a remote server to be processed and later receiving post-processed data.

### Example 1: Local Decision Science Applied to Locally Generated Data

Applying data or decision science to the locally created data may involve one or more various operations to evaluate the data (operation 220). FIG. 3B shows a flowchart for a method for evaluating locally generated data, according to an embodiment described herein. In one embodiment, as shown in FIG. 3B, the inbound data can be evaluated to determine whether it is a known known or whether it is an anomaly or a new unknown.

The inbound data can be determined to be known known at 321, for example, if the inbound data is based on existing data, answers, data science, or rules residing in the local memory, index, database, graph database, apps or other local memory or storage components). If the inbound data is determined to be “known known”, then the components and/or Intelligent Endpoint Systems may discard the XD at 350 rather than send or transmit this data through networks and other Intelligent Endpoint Systems. This operation can eliminate unnecessary network bandwidth usage and computing/storing usage.

In some embodiments, at 322 the local Intelligent Endpoint Systems can update the local and/or global data stores, graph databases, data science systems or third party systems with this known known data for statistical purposes, for example, before it discards the XD at 250. Such update may provide useful in determining whether any data generated later should be considered, for example, a known known. Alternatively at 324, the local Intelligent Endpoint System can update tags or references for this “known known” data to existing “known known” data stored locally and/or to other global Intelligent Endpoint Systems, for example, before it discards the XD at 350.

In some embodiments, at 328 the local Intelligent Endpoint System 102 can take an action, including but not limited business rules, computing requirements, workflow actions, or other actions related to this “known known” data, via the XD processing module 208, as described above. For example, the “known known” data may provide a basis for executing one or more algorithms, before the Intelligent Endpoint System discards the XD at 350. Additionally, based on a data type result, the local Intelligent Endpoint System can perform dynamic data determinant switching whereby the data type can drive a certain action, such as a business action or technical response in real-time. For example, if the number of roughly similarly characterized anomalies reach a certain number during a given time window, then an alert or a message can be sent/transmitted to a person or an administrator for deeper analysis or the system may be configured to automatically analyze and diagnose such anomalies.

In addition or in the alternative, the local Intelligent Endpoint System can combine any of the aforementioned embodiments, for example, any of steps 322, 324, 326, and /or 328 before it discards the XD or Extreme data at 350.

If the data is evaluated and determined to be an anomaly or a new unknown at 321, the Intelligent Endpoint System can update at 330 the local data stores, graph databases, index, memory, apps, or other data stores to include the anomaly or new unknown.

In some other example embodiments, as shown in FIG. 3C, the data evaluation step at 320 can comprise the local Intelligent Endpoint System automatically communicating and querying at 340 other Endpoint System(s) to determine if this data is a truly an anomaly or a “known known”. The local Intelligent Endpoint System can query at 340, for example, other Intelligent Endpoint System(s) or Intelligent synthesizer endpoint system(s) or third party systems to determine if data is an anomaly or a known known. If the query results from other Intelligent Endpoint Systems respond with no answers, then all local and global Intelligent Endpoint System data stores, graph databases, memory, apps, and third party systems can be autonomously updated with the new data at 342 and can take a corresponding autonomous action(s) at 346. If the query results from other Intelligent Endpoint Systems respond with answers indicating the data is known, then the local Intelligent Endpoint System can update its local data store, graph database, index, memory, apps, and/or third party systems and can take a corresponding action at 328.

In addition or in the alternative, the local Intelligent Endpoint System can combine any of the aforementioned embodiments, for example, any of steps 321, 322, 324, 326, 328, before it discards the known known XD at 350 and any of the aforementioned embodiments, for example, any of the steps 340, 342, 344 and /or 346 if it determines the XD is an anomaly or is unknown.

### Example 2: Localized Decision Science Applied to Locally Generated Data

Referring to FIG. 3C, if the data is an anomaly, then at 346 the original Intelligent Endpoint System can prioritize more resources to analyze or evaluate this anomaly based on business rules, data or decision science, computing availability or other operations related considerations. In some embodiments, if the response is that the new anomaly triggers an alert, for example, message(s) can be transmitted at 344 to a number (N_{P}) of people, applications, and systems similar to the Pacific Ocean Tsunami alert system.

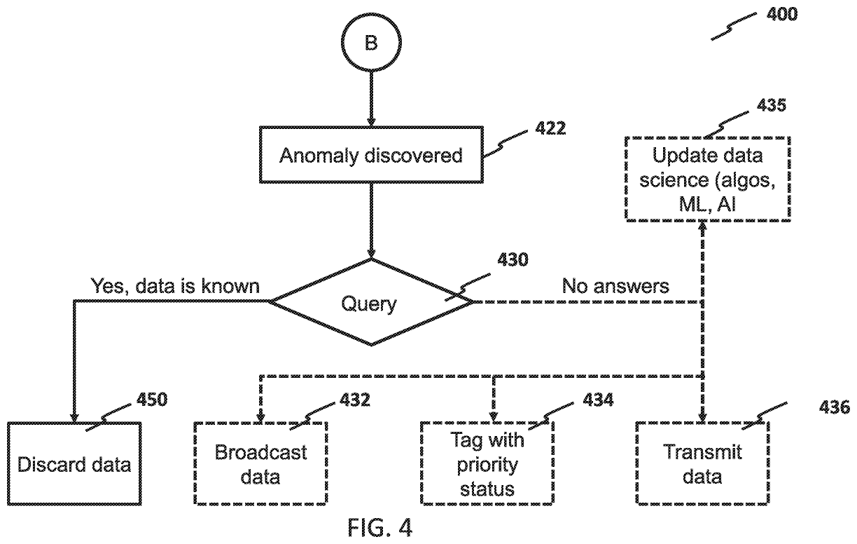

FIG. 4 shows a flowchart for another data processing method 400 for managing XD using Intelligent Endpoint Systems, according to an embodiment described herein. As shown in FIG. 4, the inbound data can be evaluated to determine whether it is a known known or whether it is an anomaly or a new unknown. In some embodiments, anomaly may be discovered after following the operations described in FIG. 3A-3C. If an anomaly is discovered at 422, the Intelligent Endpoint System can apply data or decision science (e.g. the STRIPA methodology) to send queries at 430 to other Intelligent Endpoint Systems that may know if the anomaly is wide spread (e.g., a known anomaly). If other Intelligent Endpoint Systems respond and answer that the anomaly preexists and is a “known known”, then the original Intelligent Endpoint System can proceed to discard the data at 450. If the data is determined to be unknown, for example, or if there are no answers or the response is that the anomaly does not pre-exist, then the data can be broadcasted at 432 to other Intelligent Endpoint Systems with the new information and/or data or decision science related to the new data.

In some embodiments, the newly discovered data or anomaly can be tagged, marked, or linked at 434 with a priority status for expedited processing. The newly discovered data or decision science patterns can be transmitted at 436 to other Intelligent Endpoint Systems to facilitate fast discovery and recommended actions. For example, if five (5) new anomalies have occurred in five (5) different locations around the world, the “Infer” decision science (e.g. as part of the STRIPA method) may be applied to determine that the five (5) different anomalies have similar characteristics. Based upon this common denominator anomaly profile, for instance, the Surface decision science (e.g., as part of the STRIPA method) in order to alert systems and/or people of the new potential trend.

In addition or in the alternative, the local Intelligent Endpoint System can combine any of the aforementioned embodiments, for example, any of steps 340, 342, 344, 346, and 348 shown in FIGS. 3A-3B in combination with any of steps 422, 424, 426 and 428 shown in FIG. 4.

Data or Decision Science and Software Updates

In some example embodiments, Intelligent Endpoint Systems 102 can be configured to transmit and/or receive data or decision science and/or software updates from other interconnected systems or the network 130. These updates can enable fast and automated, batch or manual software revisions to Intelligent Endpoint System indexers, database, graph, algo, data science software as new information is learned or software updates are released. Hence the Intelligent Endpoint System components, including IoT devices and/or other components not only eliminate XD noise data along the compute processing chain but these same devices get automatically smarter as time elapses by receiving these new software updates and executing these updates in real-time.

Making the response time of these Intelligent Endpoint Systems 102 smarter over time, is important in order to continually remove and/or tune these devices to better perform embodiments in Examples 1 and 2 as disclosed herein.

In some example embodiments, the Intelligent Endpoint Systems 102 have the ability to transmit and/or receive and/or execute data or decision science and/or software updates from third party systems. Additionally or in the alternative, a third party system can have the ability to transmit and/or receive data or decision science in order to update Intelligent Endpoint Systems. Any combination of the aforementioned can be performed within a method, according to an embodiment described herein.

Phase II:

Intelligent Synthesizer Endpoint System

The purpose of an Intelligent Synthesizer Endpoint System is similar to that of the Intelligent Endpoint System described in Phase I above. In particular, an Intelligent Synthesizer Endpoint System can have the same data or decision science execution, processing, and embodiments as a Phase I Intelligent Endpoint System with certain specifications as detailed below.

Intelligent Synthesizer Endpoint System have more compute power, memory, and storage capacity than other Intelligent Endpoint Systems. The additional compute capability facilitates more analytic, data science (e.g., ML, Al, algorithms) and general computing power to process and answer more challenging data or decision science questions and recommendations for other Intelligent Endpoint Systems. In one embodiment, the Intelligent Synthesizer Endpoint Systems take data anomalies from one or more Intelligent Endpoint Systems and begin performing automated or batch oriented data or decision science, which can result in responses including but not limited to STRIPA based preemptive business recommendations and actions.

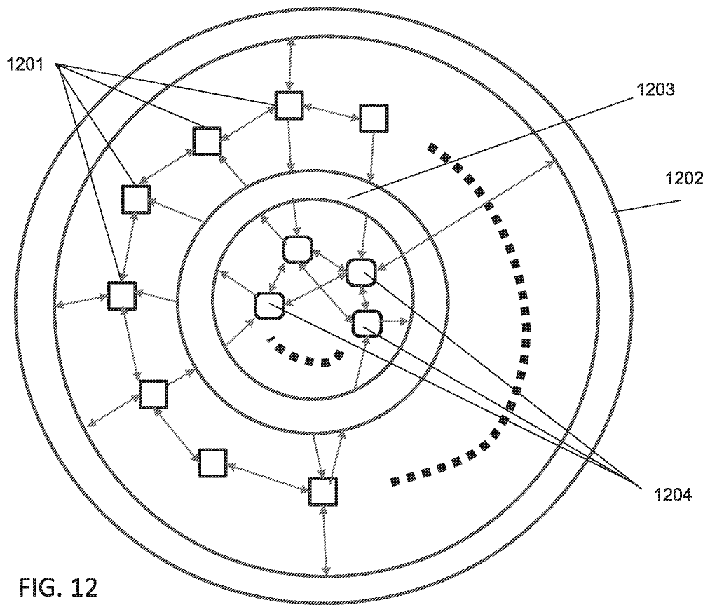

In some embodiments, the Intelligent Synthesizer Endpoint Systems approximate missing information and/or data, using a variety of data or decision science techniques, and insert these approximations and estimations into a data store, graph database, applications, and third party systems. In another example aspect, Intelligent Synthesizer Endpoint Systems also transmit and/or receive data or decision science, software updates, and other data from the Intelligent Transceiver. These updates to the Intelligent Synthesizer Endpoint Systems can enable fast and automated software revisions to synthesizer indexers, database, graph, data or decision science, and data as new information is learned or software updates are released from other Intelligent Endpoint Systems, systems, and third party systems. These real-time, batch, and manual updates can enable the Intelligent Synthesizer Endpoint System to become smarter and faster over time. An Intelligent Synthesizer Endpoint System as disclosed herein can comprise any combination of the aforementioned features or embodiments. An example of the Intelligent Synthesizer Endpoint System is also discussed with respect to FIG. 12 below.

Intelligent Third Party Endpoint Systems

The purpose of Intelligent Third Party Endpoint System is to integrate data or decision science computing platforms and ecosystems spanning a number of different computing and data ecosystems, platforms, and enterprises. Computing and data ecosystems, platforms, and enterprises include but are not limited to strategic business partners, organizations, virtual environments, public and private market places, government organizations, not for profit organizations, and other organizations. An example of these third party computing and data ecosystems, platforms, and enterprises are shown in FIG. 12.

Virtual environments may generally refer to any environment created by utilizing virtual reality and/or augmented reality technologies. In an example embodiment, virtual reality (VR) headsets, VR devices, augmented reality devices and mixed reality devices incorporate or comprise Intelligent Endpoint Systems, and may be configured to execute localized data science or decision (e.g., XD processing onboard the VR headset).

In another example embodiment, an Enterprise A can have a cloud based system with its own data. Enterprise A may need the expertise of data or decision science focused cloud Business B in order to analyze and recommend data or decision science driven actions. In this case, an Intelligent Third Party Endpoint System(s) (can also be referred to as “node”) can be an integration point for Enterprise A and Business B.

In another example aspect, this Intelligent Third Party Endpoint System exists in a public or private cloud such as for example, Amazon, Google, CenturyLink, or RackSpace to name a few, or it can reside at Enterprise A, Business B, or any combination of the aforementioned locations.

In another example aspect, this Intelligent Third Party Endpoint System includes connectors, including but not limited to APIs so that Enterprise A can utilize Business B′s data or decision science and simultaneously not allow Business B to see Enterprise A′s data and results for privacy purposes.

In another example aspect, there are multiple Enterprises using the Intelligent Third Party Endpoint System(s).

In another example aspect, an Enterprise can license and run the Intelligent Third Party Endpoint System in their private network and behind their firewall. For example a car manufacturer or a pharmaceutical company may need to pull in massive data or decision science to help the company make R&D decisions, product marketing decisions, and advertising decisions.

In some example embodiments, the Intelligent Third Party Endpoint System(s) transmit and receive data or decision science, software updates, and data from other systems or the network 130. These updates can enable fast and automated data or decision science, software revisions, and data to indexers, database, graph, algos, ML, Al software, and apps as new information is available and released, which can make the Intelligent Third Party Endpoint Systems smarter and faster over time. An Intelligent Third Party Endpoint Systems as disclosed herein can comprise any combination of the aforementioned features or embodiments.

Other Types of Intelligent Endpoint Systems

Intelligent Endpoint Systems may also include “Master Data” Endpoint Nodes, which can comprise Intelligent Master Database Management software and systems. Master Data Endpoint nodes (e.g., one or more Intelligent Endpoint Systems with master data) may generally refer to master databases that contain reliable and trustworthy data, which can be relied on by other systems or devices for verification purposes.

For example, a customer CRM system that contains information such as customer name, address, and billing information is a basic form of the single source of truth system. There can also be Application Specific Endpoint Nodes specialized to perform tasks for a particular application.

In another example embodiment, Intelligent Endpoint Systems can fall into two families: Parent Endpoint Systems and Child Endpoint systems. A Parent Endpoint Systems comprises a superset of Child Endpoint System features and functionalities and is typically characterized as having more compute, store, and data or decision science capability relative to Child Endpoint Systems. Tasks that Parent Endpoint Systems can perform include: providing data or decision science driven (e.g. algo, ML, or Al-based) preemptive actions and recommendations to other Parent and Child Endpoint systems; responding to queries from other Parent and Child Endpoint systems including, but not limited to, user initiated data, decision science queries, as well as machine to machine initiated data or decision science based queries; performing data or decision science (e.g. algo, ML, Al, machine vision) on the master data stores; synthesizing data residing in the stores to identify, infer, and/or predict emerging consumer, business and technology related trends, correlations (for example, using the STRIPA methodology); receiving data from one or more Parent and Child Endpoint Systems in order to fill in or complete missing master data, including but not limited to data store, metadata stores, graph data stores, third-party systems, and other data science data stores; performing master data management functionality relative to other Parent and child Endpoint Systems; transmitting master data to other Parent and Child Endpoint Systems (Transceiver); performing the transceiver functionality by receiving data (listening and ingesting data over a number of channels, frequencies, wired and wireless networks, and other transmission channels) and by transmitting data, metadata, and data or decision science to other Parent and Child Endpoint Systems.

By contrast, child Endpoint Systems may just have one or two of the aforementioned tasks, features, and/or functions.

The interactions between a Parent and Child Endpoint systems can interact using a number of different approaches. One strategy is using a traditional network credentialing process whereby the Parent has “Admin” rights and the child is granted some or all Parent Admin rights to perform compute tasks.

In another example embodiment of a Parent/Child interaction strategy, the Child Endpoint System asks a Parent Endpoint System for permission for out-of-band compute tasks. Out-of-band compute tasks include processing, receiving, transmitting, or a combination thereof, data, metadata, and data science (e.g. Al, ML, and STRIPA). Out-of-band compute tasks can be defined as, for example, compute tasks that do not fall within a list of in-band compute tasks. In another example, out-of-band tasks and in-band tasks are determined based on credentials associated with a Child Endpoint System. In another example, out-of-band tasks and in-band tasks, and the provisioning of permission to a Child Endpoint System is dynamically determined by conditions, including, but not limited to one or more of: the type of computing task, voting, bandwidth capability, processor performance capability, memory capability, data science, business rules, and compute goals/objectives.

In an example embodiment, a Child Endpoint System asks one or more Parent Endpoint Systems to use the computing hardware (e.g. processor, memory, communication module, actuator module, etc.) of one or more given Parent Endpoint Systems or one or more other Child Endpoint Systems, or both.

In another example, all Endpoints are Parent Endpoint Systems and are governed by a centralized or a decentralized governance system(s) to perform computations.

Intelligent Endpoint System Walkthrough and Processing Examples

In some embodiments, an Intelligent Endpoint System can be inserted at a point where data is first created. A number of different Intelligent Endpoint Systems can be inserted at points where data is first created, each generating machine data and metadata, user generated data and metadata, system data and metadata.

For example, a given Intelligent Endpoint System or another system (e.g. central server, cloud server, third party Endpoint System, etc.) detects data being first created, measured, computed at a certain location. The location can be physical or digital, or a combination of both. A digital location can include one or more of: an IP address, DNS address, URL, virtual IP address, TOR node, email address, web domain address, proxy address, device ID, a network ID (e.g. local network, BlueTooth network, WiFi network, cellular network, radio frequency ID, radio channel ID), repeater ID, etc. One or more other Intelligent Endpoints Systems are provisioned, deployed or inserted at that certain location.

In an example aspect, after detecting that the data is an anomaly, then the one or more Intelligent Endpoint Systems are provisioned, deployed or inserted at that certain location.

In an example aspect, there are existing devices or existing Intelligent Endpoint Systems already at the certain location, and these Intelligent Endpoint Systems are provisioned with microcode to execute certain computations (e.g. monitor for related data, compute related data, generate related data, store related data, communicate related data, take physical action responsive to related data, etc.). In another example aspect, Intelligent Endpoint Systems move to the certain location, either under their own power (e.g. their own actuators that provide motive force) or by another device or process (e.g. flow of fluid, flow of material, gravity, orbital path, wind power, etc.) that transports the Intelligent Endpoint Systems to that certain location. In an example embodiment, a dispenser device dispenses one or more Intelligent Endpoint Systems at the certain location.

Additionally, each Intelligent Endpoint system can comprise data or decision science STRIPA intelligence, wherein intelligence includes but is not limited data or decision science that: can apply STRIPA filters and can ignore “known known” answers and data; can apply STRIPA to sense and detect certain types of data, patterns, images, audio, multimedia, etc. and to update Endpoint systems and/or notify users, and/or update third party systems; can apply STRIPA to reference, tag and/or index known known an or new anomaly or new unknowns; can apply STRIPA to the data and can take action(s) including but not limited applying automated or batch oriented business rules, applying automated or batch oriented apps, or performing system or workflow actions using data science and/or business rules; can apply STRIPA to the data and can take action(s) including but not limited to applying automated or batch oriented business rules, applying automated or batch oriented apps, performing system or workflow actions using algos and/or business rules based on a prioritizing algorithm or rules; can apply STRIPA to the data and can send alerts and messages to other Endpoint System(s), synthesizer(s), and third party Endpoint Systems to alert and fast track irregularities and/or new unknowns.

Intelligent Endpoint System Step by Step Flow

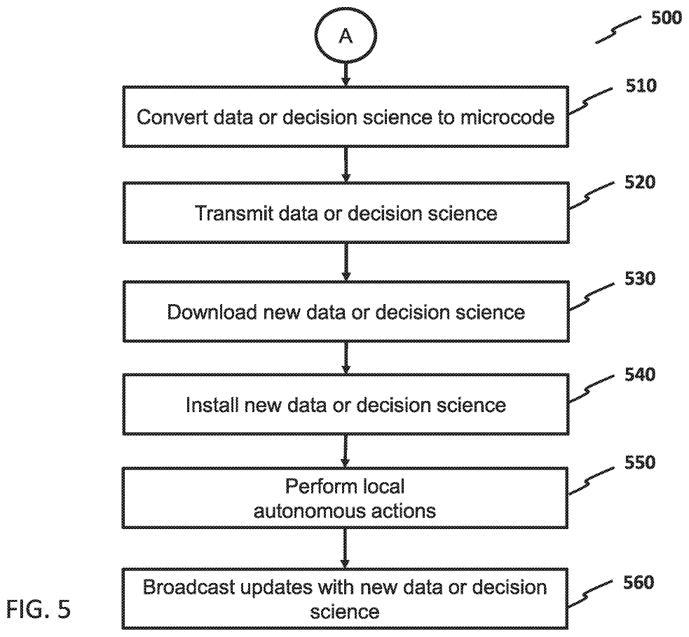

FIG. 5 shows a flowchart of a method 500 for updating an Intelligent Endpoint System. In some example embodiments, Intelligent Endpoint System (e.g., creating or processing IoT data) data or decision science can be automatically developed and automatically converted to FPGA based microcode at 510. The Intelligent IoT data or decision science can be transmitted at 520 over network(s) (e.g., network 130). Updated data or decision science and can be downloaded, automatically, for example, at 530. The Intelligent Endpoint System can be configured to automatically install the downloaded data or decision science, or can “flash” the new data or decision science at 540 into an FPGA. Alternatively, the operation at 540 may involve updating the existing data or decision science on the FPGA. The Intelligent Endpoint System is then operationalized using the latest data or decision science. Such installation or update may be performed autonomously or may be configured to be performed at certain intervals or may be triggered by certain events.

Other example features and embodiments of the Intelligent Endpoint Systems are provided below.

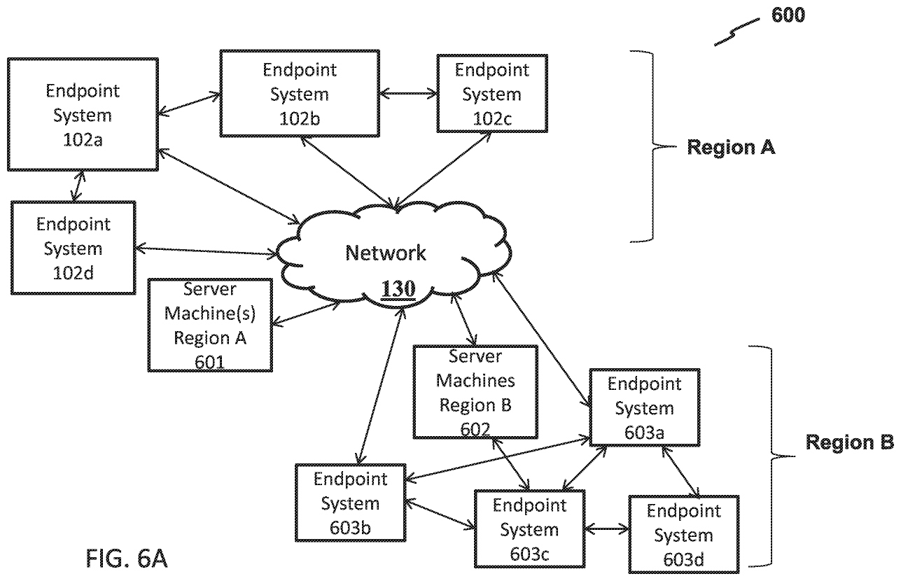

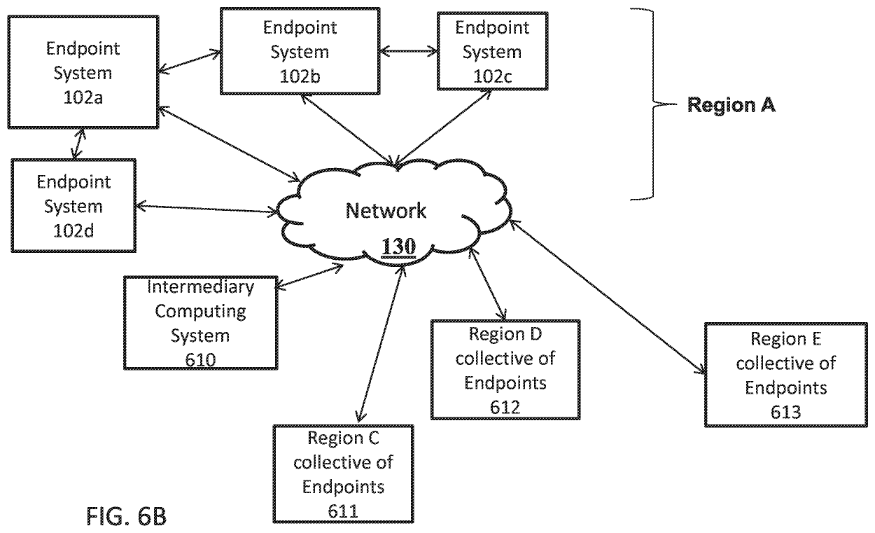

In an example shown in FIG. 6A, an Intelligent Endpoint System architecture 600 is provided that includes a first group of Intelligent Endpoint Systems 102a, 102b, 102c, 102d that are located and operate in Region A, and a second group of Intelligent Endpoint Systems 603a, 603b, 603c, 603d that are located and operate in Region B.

In this example, the first group and the second group are grouped by regions. However, other parameters or characteristics can be used to define the groupings.

There also includes, for example, one or more server machines 601, 602 that are intermediaries between the first group and the second group. These server machines for example are part of a cloud computing system. In the example shown in FIG. 6A, there are one or more server machines in Region A 601 and one or more server machines in Region B 602. In another example, not shown, there is one intermediary or central computing system between both Region A and Region B.

Within Region A there may not be an anomaly detected within that region because the data in that region, for example, is data science “normalized” and a “known known”. Region B, by contrast, does not know about Region A′s data conditions and characteristics (“normalized” and a “known known” data”). If data from Region A were processed by Region B's Intelligent Endpoint Systems and regional cloud, the data science and respective Intelligent Endpoint Systems in Region B would have been marked an anomaly. To resolve these conditions, the centralized computing (e.g. intermediary compute system, like an observer) would have been the first to detect, surface, and present the anomaly between Region A data and Region B data. In this case, the centralized computing would exemplify the first to discover approach. This example shows that a first-to-discover strategy could occur anywhere in the ecosystem and not necessarily at an Intelligent Endpoint System or a regional cloud.

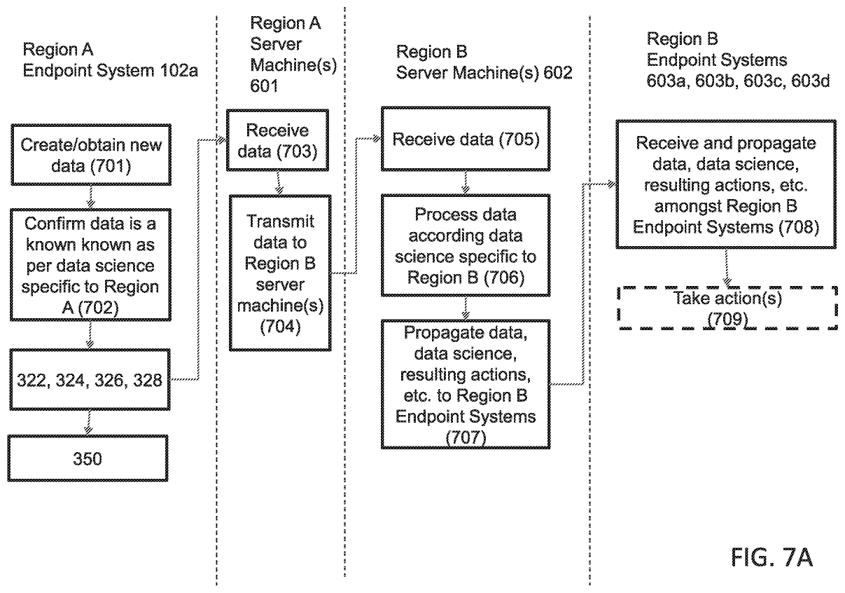

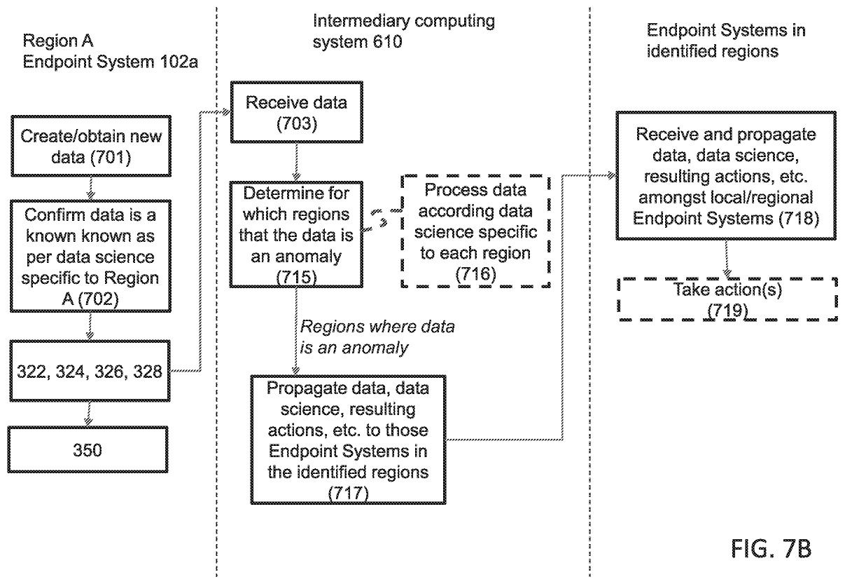

FIG. 7A shows an example process that uses the architecture shown in FIG. 6A. In FIG. 7, an Endpoint System 102a in Region A creates, captures, detects, generates, etc. new data (block 701). The Endpoint System 102a confirms that the data is a known known as per data science that is specific to Region A (block 702).

Following block 702, one or more of blocks 322, 324, 326, 328 are implemented, followed by block 350. In an example embodiment, the Endpoint System 102a transmits the same data to the server machine 601 in Region A. This data is received by the server machine 601 and passed onto the server machine 602 in Region B (block 703, 704).

The server machine 602 receives the data (block 705) and processes this data according to data science that is specific to Region B (block 706). In doing so, the server machine 602 characterizes this data an anomaly. As a result, this data (e.g. and related data science, resulting actions, etc.) are propagated to other Intelligent Endpoint Systems in Region B (blocks 707, 708). In an example aspect, these Intelligent Endpoint Systems in Region B then execute one or more actions based on this anomaly.

FIGS. 6B and 7B show another example embodiment of an architecture of Intelligent Endpoint Systems and a corresponding computing process. In FIG. 6B, Region A includes multiple Intelligent Endpoint Systems 102a, 102b, 102c, 102d. There are other collectives of Intelligent Endpoint Systems that are grouped by other regions. For example, in Region C there are a collective of Intelligent Endpoint Systems 611; in Region D there are a collective of Intelligent Endpoint Systems 612; and in Region E there are a collective of Intelligent Endpoint Systems 613. An intermediary computing system 610 communicates with one or more Intelligent Endpoint Systems in each region. The intermediary computing system 610 is able to determine data from one region could be an anomaly in another region. An example process for making this determination is shown in FIG. 7B.

In FIG. 7B, an Intelligent Endpoint Systems 102a from Region A sends data, which is a known known in Region A, to the intermediary computing system 610, which is received at block 710. The intermediary computing system 610 determines for which regions that the data is an anomaly (block 715). For example, in implementing block 715, the intermediary computing system processes the data according data science that is specific to each region (block 716). After identifying the region(s) in which the data is an anomaly, the intermediary computing system 610 propagates the data, data science, resulting actions, etc. to the one or more Intelligent Endpoint Systems in the identified region(s) (block 717). The one or more Intelligent Endpoint Systems in the identified region(s) receive and propagate the data, data science, resulting action, etc. amongst the other Intelligent Endpoint System in their shared region (block 718). These same Intelligent Endpoint System could optionally take action (block 719).

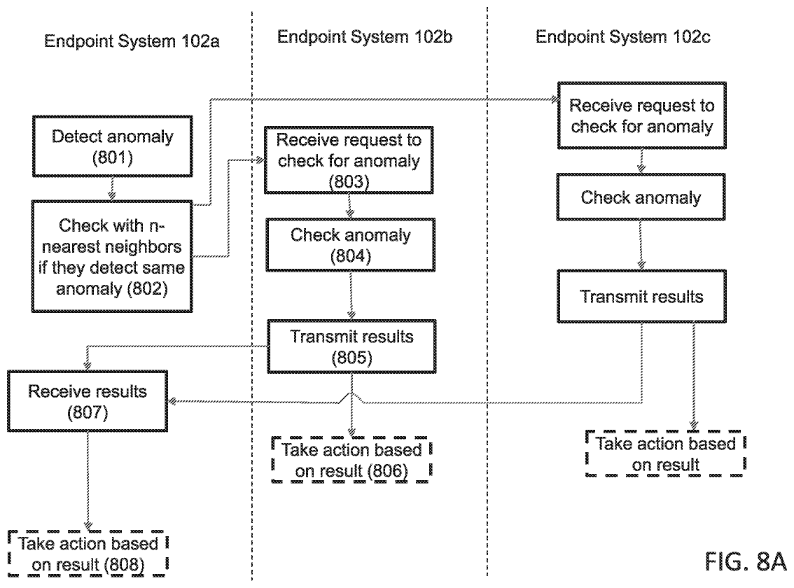

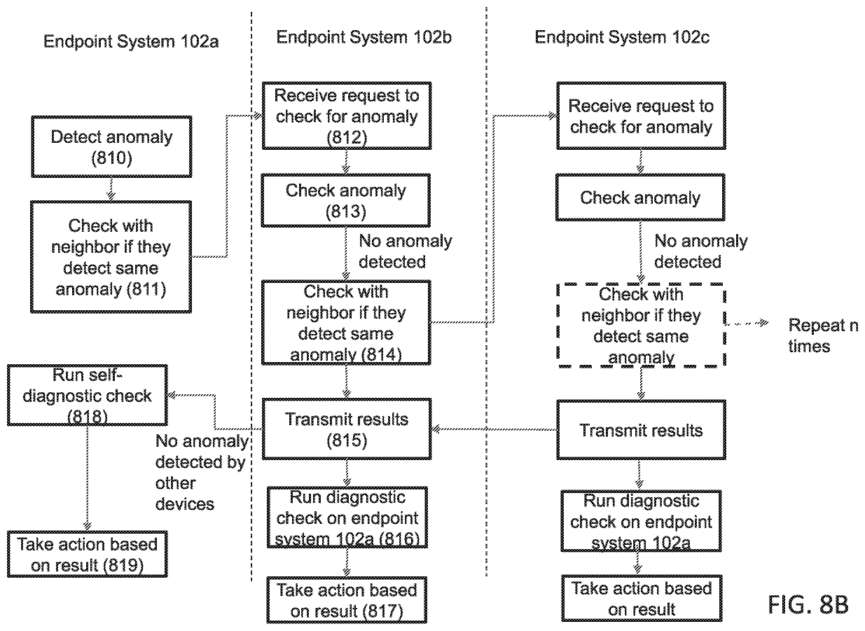

Turning to FIG. 8A, another example embodiment is shown in which a first Intelligent Endpoint System 102a locally detects an anomaly (block 801) and performs a check with n-nearest neighbors to determine if they have detected the same anomaly (block 802). For example, the Intelligent Endpoint System 102a identifies the n-nearest neighbors (or finds any neighboring devices within a given distance, or find devices on a given bandwidth, or finds other devices according to some other condition), and transmits a request to these other devices to check for the anomaly.

For example, another Intelligent Endpoint System 102b receives this request (block 803), performs a check to see if the same anomaly is detected locally (block 804), and transmits the results back to the first Intelligent Endpoint System 102a (block 805). The Intelligent Endpoint System 102b, for example, also takes action based on the results of performing the check (block 806). These operations 803, 804, 805, 806 are also performed by other Intelligent Endpoint Systems in parallel (or in serial), such as the Intelligent Endpoint System 102c.

The first Intelligent Endpoint System 102a receives the results from the one or more other Intelligent Endpoint Systems (block 807). The first Intelligent Endpoint System 102a, for example, also takes action based on these received results (block 808).

For example, the other Intelligent Endpoint Systems 102b, 102c do not detect the anomaly and continue to locally monitor to see if they are able to detect the anomaly in the future. These Endpoints 102b, 102c also propagate a risk of the anomaly to other Intelligent Endpoint Systems (e.g. which could be further removed from the first Intelligent Endpoint System 102a), which in turn initiates these other Intelligent Endpoint Systems to also monitor for the anomaly.

In another example, the other Intelligent Endpoint Systems 102b, 102c do detect the anomaly. A message is spread through the network of Intelligent Endpoint Systems with respect to the detected anomaly. Actions may be taken by one or more of the Intelligent Endpoint Systems in reaction to detecting the anomaly.

In another example embodiment of taking action if an anomaly is detected, one or more Intelligent Endpoint Systems, which are in a larger network of Intelligent Endpoint Systems, are hived off or isolated to form a sandbox. In an example aspect, the one or more Intelligent Endpoint Systems that form the sandbox are selected (e.g. self-selected or appointed by other Intelligent Endpoint Systems in the network) based on some condition. For example, the condition is that the selected Intelligent Endpoint Systems are: the ones that detected the anomaly; the n-nearest Intelligent Endpoint Systems that are closest to the Intelligent Endpoint System that detected the anomaly; the Intelligent Endpoint Systems that have certain hardware or certain software (or both) to compute response actions; or a combination thereof. After the sandbox of Intelligent Endpoint Systems is formed, these sandboxed Endpoints compute response actions. For example, the response actions include one or more of: identifying the source or cause of the anomaly; recreating the anomaly; identifying the effects of the anomaly; removing of the anomaly; and amplifying the effects of the anomaly. The desired data, processes, and outcomes obtained from the sandbox are then transmitted to other Intelligent Endpoint Systems in the network. If the Intelligent Endpoint Systems in the sandbox are compromised, damaged, misappropriated, etc. during the computing of the response actions, then these sandboxed Intelligent Endpoint Systems are permanently removed from the network, or are shutdown, or both.

FIG. 8B shows another example embodiment, however, that is specific to the situation in which no anomaly is detected by neighboring Intelligent Endpoint Systems.

In particular, at block 810, a first Intelligent Endpoint System 102a detects an anomaly and checks with a neighboring device if they detects the same anomaly (block 811). For example the second Intelligent Endpoint System 102b is the closest neighbor to the first Intelligent Endpoint System 102a and therefore, it receives the request to check for the anomaly (block 812). The second Intelligent Endpoint System 102b checks to see if it detects the same anomaly (block 813), does not detect the anomaly, and then checks with a neighboring third Intelligent Endpoint System 102c to see if it has detected the same anomaly (block 814).

The third Intelligent Endpoint System 102c executes the same operations (blocks 812 to 814). The result or results from the Intelligent Endpoint Systems 102b and 102c are transmitted back to the first Intelligent Endpoint System 102a (block 815), namely that no anomaly has been detected by other devices. These operations could, for example, also be repeated by n additional Intelligent Endpoint Systems.

The second Intelligent Endpoint System 102b runs or executes a diagnostic check on the first Intelligent Endpoint System 102a (block 816). For example, the diagnostic check helps to determine if the first Intelligent Endpoint System 102a has been compromised, damaged, hacked, misappropriated, anomalously relocated, etc. Depending on the result of the diagnostic check, the second Intelligent Endpoint System 102b could take action based on the result (block 817). The same operations at blocks 816, 817 are also repeated by the third Intelligent Endpoint System 102c.

The first Intelligent Endpoint System 102a, in response to receiving that no anomaly has been detected by other devices, runs a self-diagnostic check (block 818). Depending on the results, it could also take action (block 819).

In an example operation at block 817, if the one or more other Intelligent Endpoint Systems detect that the first Intelligent Endpoint System 102a is compromised, then they eject or ignore communications from the first Intelligent Endpoint System 102a and no longer transmit communications to the first Intelligent Endpoint System 102a.

In another example of block 817, the one or more other Intelligent Endpoint Systems reflash the first Intelligent Endpoint System 102a.

In another example of block 817, the one or more other Intelligent Endpoint Systems apply a lower weighting value on a data integrity score for data transmitted by the first Intelligent Endpoint System 102a.

In another example of block 817, the one or more Intelligent Endpoint Systems create a condition that requires confirmation of n other Intelligent Endpoint Systems (e.g. that are in proximity to the first Intelligent Endpoint System 102a) to confirm the data from outputted from the first Intelligent Endpoint System 102a (e.g. including confirming that the data is a known known or an anomaly). In an example embodiment, the n other Intelligent Endpoint Systems are the n-nearest neighbors of the first Intelligent Endpoint System 102a.

In an example embodiment, if the first Intelligent Endpoint System 102a detects that it is compromised, then it self-destructs at block 819.

In another example embodiment of block 819, if the first Intelligent Endpoint System 102a detects that it is compromised, then it reflashes itself with new microcode.

In other words, as per FIG. 8B, the first Intelligent Endpoint System itself is the anomaly and is dealt with by action.

In a different example embodiment of the Intelligent Endpoint Systems, the inherent architecture of the multiple Intelligent Endpoint Systems that are in relational communication with each other (e.g. peer-to-peer) is used to form a graph database. Typically a graph database is implemented on one server, or on one set of servers. A graph database comprises virtual nodes and virtual edges between the virtual nodes, representing relationships between the virtual nodes. However, in an example embodiment, a graph database is herein defined by nodes that are respectively the Intelligent Endpoint Systems, and the edges between the nodes in the graph database are the actual communication links between the Intelligent Endpoint Systems. The data or metadata associated with each node in the graph database is physically stored in memory devices of each respective Intelligent Endpoint System. For example, data stored in relation to a first node in the graph database is physically stored in a memory device on a corresponding first Intelligent Endpoint System; data stored in relation to a second node in the graph database is physically stored in a memory device on a corresponding second Intelligent Endpoint System; and so forth. In other words, the graph database takes on the shape and characteristics of the collection of Intelligent Endpoint Systems. In an example embodiment, the graph database contains both data from the IES sources and anomalies, and metadata such as data and anomaly trends, IES computing utilization, network issues, business goals achieved. Storing the data and metadata in a graph database makes current and future processing more effective and efficient because data science (e.g. Al, ML, and STRIPA) can identify patterns sooner and faster in the graph database and then realtime select the right resources to perform IES computing. Storing the data and metadata in a graph database can also help eliminate duplicate data, duplicate metadata, and duplicate knowns, which in turn reduces both computing, storing, and network processing costs and increases end to end compute efficiency.

In an example aspect of the graph database embodiment, a graph database mapping is provided that includes the Intelligent Endpoint Systems IDs and their edge relationships. The graph database mapping (which is different from the graph database itself) does not store the data of each Intelligent Endpoint itself. Instead, data of each node of the graph database is physically stored on the respective Intelligent Endpoint Systems.

In another example aspect, the network of Intelligent Endpoint Systems include public and private data stored on public and private systems. For example, a private Intelligent Endpoint System locally stores private data; a private Intelligent Endpoint System owns and retrieves its private data from a 3^{rd} party system (e.g. a cloud computing system or other Intelligent Endpoint Systems); a private Intelligent Endpoint System locally stores public data; and a private Intelligent Endpoint Systems retrieves public data from a 3^{rd} party system (e.g. a cloud computing system or other Intelligent Endpoint Systems). Therefore, the graph database is physically made of 3^{rd} party systems and private Intelligent Endpoint Systems, with private and public data stored on a combination of the 3^{rd} party systems and the private Intelligent Endpoint Systems. A graphing database mapping includes metadata about content stored on each node, such as whether the data is private or public, who it belongs to, the date of creation, etc.

In another example embodiment of Intelligent Endpoint Systems, a nearest neighbor blind processing and blind storage is applied for privacy objectives. In this example, self-identifying characteristics such as patient name, social security number, personally identifiable information, etc. are stripped out of the original Intelligent Endpoint System before executing computations to detect anomalies, or before cloud computing is performed. The resulting anonymized data is processed by nearest neighbor devices, compute clouds, third party processors, or any combination of the aforementioned, in order to compute first-to-detect and/or validate anomalies. In another example aspect, immutability and/or blockchain storage is used to store the anonymized data. Example applications could include, and are not limited to, Health Insurance Portability and Accountability Act (HIPAA) compliance and General Data Protection Regulation (GDPR) compliance.

A different strategy is load balancing the Intelligent Endpoint Systems and/or compute clouds. In this example, the device and or cloud has intelligent compute thresholds, such as transactions per second or read/write actions per second, and the IES begins load balancing its compute with neighboring devices using software and/or hardware.

A different IES strategy is to make all or some of the IES devices and/or compute clouds role agnostic whereby any IES device can swap roles with another IES device or compute cloud; a compute cloud could swap roles with another IES compute cloud or IES device. Software or hardware, or both, can run scripts that make these changes and consequently swap IES endpoint roles.

Another example of an IES strategy is to intelligently combine IES devices and/or compute clouds and/or third party systems to collectively create a IES based neural network. Metaphorically, this is similar to a neuron and synapse where each IES device is a neuron and the synapses are the networks. The collective IES devices and or compute clouds and the networks perform computations to achieve a business goal, company objective, engineering task, etc. The IES and networks each have their own data science (e.g. Al, ML, and STRIPA algos) to perform specialized neural computing and or have overarching data science to optimize among the collective devices, computing clouds, and networks to achieve a goal or objective.

Another example of an IES strategy involves IES devices that physically move and, at the same do one or more of the following: carry data, execute computations, sense or detect new data, perform actions, produce or manufacture a thing, etc. The IES device can perform onboard compute to re-optimize its destination paths, processes or tasks to achieve a goal or optimize toward a goal, etc. These devices may confer with other devices or compute clouds for data and or computations in order to perform the recurring optimizations over time. These IES devices may confer with other devices and compute clouds to load balance and share work or tasks based on the outcomes, goals, tasks, business rules, conditions, or any combination of the aforementioned.

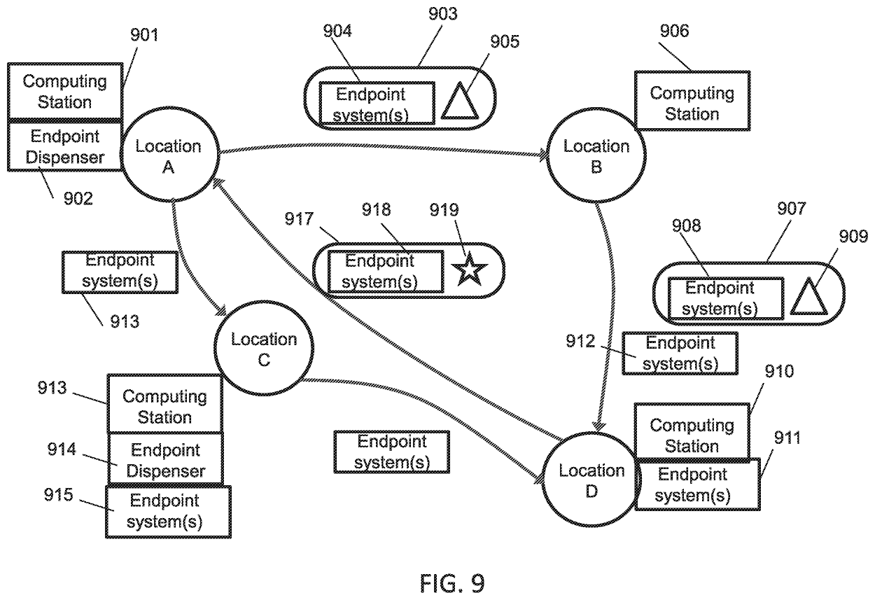

Turning to FIG. 9, an example IES environment shows different locations, namely Location A, Location B, Location C, and Location D. Intelligent Endpoint Systems physically move from one location to another. For example, at Location A, there is a computing station 901 and an Endpoint dispenser 902. The computing station 901 interacts with Intelligent Endpoint Systems located at Location A, for example, by exchanging code, data, etc. In an example embodiment, lower power Intelligent Endpoint Systems do not have the ability to connect to the Internet directly or to connect directly to other cloud computing devices. Therefore, the lower power Intelligent Endpoint Systems that are at Location A locally connect to the computing station 901, and via the computing station 901, can download or upload (or both) data or code to other networks and platforms (e.g. the Internet, other private networks, cloud compute platforms, etc.).

The computing station 901 also interacts with the Endpoint dispenser 902, which in turn dispenses Intelligent Endpoint Systems. For example, based on commands, objectives, feedback (from other Intelligent Endpoint Systems or from other computing devices), business rules, data science, conditions, etc., the computing station 901 in turn commands or controls the Endpoint dispenser 902 to dispense Intelligent Endpoint Systems. In an example embodiment, the Endpoint dispenser controls one or more of the following aspects: controls how many Intelligent Endpoint Systems are dispensed; controls the direction of where the Intelligent Endpoint Systems are dispensed; controls the data and the code residing on the Intelligent Endpoint Systems that are dispensed; and controls the frequency and timing of the dispensing of the Intelligent Endpoint Systems.

In an example aspect, the Endpoint dispenser 902 can upload data and code to the Intelligent Endpoint Systems. For example, the Endpoint dispenser flashes the Intelligent Endpoint Systems. In another example aspect, the Endpoint dispenser itself acts as an Intelligent Endpoint System in a network of Intelligent Endpoint Systems. In another aspect, the Endpoint dispenser includes actuators to dispense Intelligent Endpoint Systems. In other words, the Endpoint dispenser 902 is a mechanism that provisions Intelligent Endpoint Systems.

In an example embodiment of an Endpoint dispenser 902, the Endpoint dispenser 902 includes a container that holds or stores Intelligent Endpoint Systems that are to be dispensed. In an example aspect, the Endpoint dispenser 902 flashes all the Intelligent Endpoint Systems within the container at the same time. In another example aspect, the Endpoint dispenser 902 flashes a given Intelligent Endpoint System as part of the process of dispensing the given Intelligent Endpoint System from the container.

In another example aspect, the Endpoint dispenser 902 first flashes all the Intelligent Endpoint Systems within the container at the with a first code and/or data portion; and, at later time, secondly flashes one or more given Intelligent Endpoint Systems with a second code and/or data portion as the one or more given Intelligent Endpoint Systems are being dispensed from the container. For example, the first code and/or data portion is considered base code that applies to all the Intelligent Endpoint Systems stored within the container, and the second code and/or data portion is customized for the tasks, functions, or goals of the given Intelligent Endpoint Systems that are later being dispensed. This efficiently provides just-in-time flashing for customizable code and/or data portions.

In another example embodiment, an Endpoint dispenser 902 does not store the Intelligent Endpoint Systems, but includes mechanisms (e.g. actuators) to dispense the Intelligent Endpoint Systems.

Continuing with FIG. 9, a transporter 903 carries one or more Intelligent Endpoint Systems 904 and one or more other things 905 from Location A to Location B. The transporter 903, for example, is a manned vehicle or an unmanned vehicle, or some other type of transport mode. Non-limiting examples include cars, trucks, trains, aircraft, spacecraft, boats, bicycles, scooters, people that carry an Intelligent Endpoint System, drones, conveyor systems, material handling robots, etc. When the transporter 903 arrives at Location B, the computing station 906 located at Location B can interact with the Intelligent Endpoint System(s) 904. The computing station 901, which knows or plans that the Intelligent Endpoint System(s) 904 travel from Location A to Location B, inserts data or code, or both, via the Endpoint dispenser 902, into the Intelligent Endpoint Systems 904.

In an example embodiment, while these Intelligent Endpoint Systems 904 move from Location A to Location B, the Intelligent Endpoint Systems 904 carry the data or the code; or the Intelligent Endpoint Systems 904 execute computations; or the Intelligent Endpoint Systems 904 sense, obtain or capture data from their local environment; or the Intelligent Endpoint Systems 904 manufacture, build, perform an action, etc.; or a combination thereof. For example, the Intelligent Endpoint Systems 904 monitor the things 905 while in transport. In another example, the Intelligent Endpoint Systems 904 consume or modify, or both, the things 905 while in transport. In another example, the Intelligent Endpoint Systems 904 manufacture more of the things 905 while in transport. The original data or code, or derivatives thereof, or outputs (e.g. digital or physical outputs, or both), or combinations of the aforementioned, are provided at Location B. For example, data or code are provided to the computing station 906 at Location B.

In other words, while the Intelligent Endpoint Systems 904 are in transit, they perform a function. The Intelligent Endpoint Systems 904 can be low powered and may purposely avoid connecting to a larger data network while in transit in order to save power.

The computing station 906 can act as a repeater and upload data and code (e.g. the original data or code from the computing station 901, or derived or outputted data from the Intelligent Endpoint System 904 while moving to Location B, or both) to other Intelligent Endpoint Systems 908. In turn, the Intelligent Endpoint Systems 908, along with other things 909, are physically transported by a transporter 907 from Location B to Location D. After it arrives at Location D, the Intelligent Endpoint Systems 908 provide the data or code, or both, to the computation station 910. Other Intelligent Endpoint Systems 911 are, for example, also held or aggregated at Location D. These Intelligent Endpoint Systems 911 can be deployed to other locations.

In another example aspect, Intelligent Endpoint Systems 912 and 913 can be incorporated or part of a transporter and, therefore, can move on their own between locations. In other words, various transport devices and transport vehicles 912, 913 themselves are Intelligent Endpoint Systems.

Data or processing, or both, can be shared amongst different Intelligent Endpoint Systems 908, 912, if they are in close enough proximity to each other. For example, the Intelligent Endpoint Systems 908 and 912 are on the same path (or are crossing paths) between Location B and Location C.

The distribution of data, processing, and other actions (e.g. manufacturing, building, performing an action, etc.) can be distributed amongst these moving Intelligent Endpoint Systems and can be optimized based on their paths to different locations. Other parameters can be used to optimize the distribution of computing amongst these Intelligent Endpoint Systems, and these parameters could also be used to plan and affect the travel paths of the Intelligent Endpoint Systems.

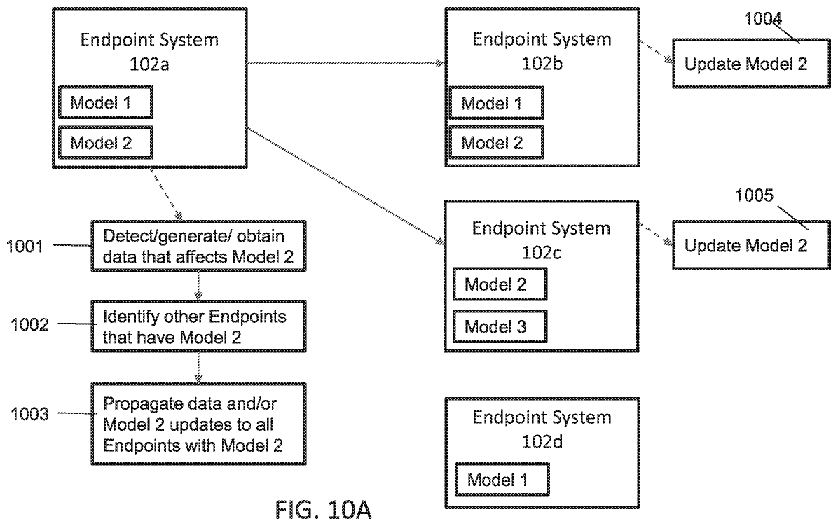

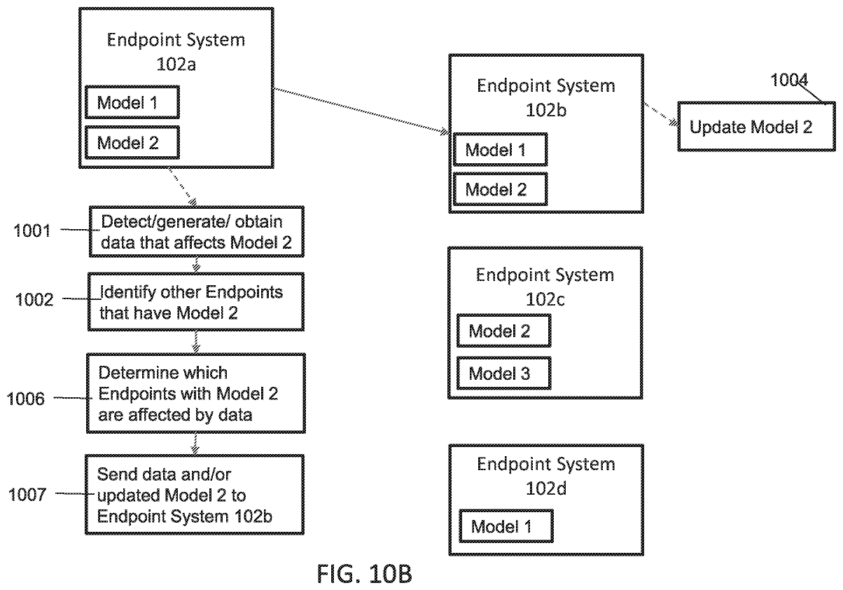

Turning to FIG. 10A, another example embodiment shows Intelligent Endpoint Systems 102a, 102b, 102c, 102d coordinating data updates with each other. In this example embodiment, each of the Intelligent Endpoint Systems have stored thereon one or more models. A model is a set of code and data. A model could be one or more of: a blockchain, a database, an immutable ledger, a 3D virtual environment that represents a real world or physical world, a simulation, a social network model, a chemical model, a business model, a medical model, a manufacturing model, a distribution model, a model of a physical object or physical system, etc.

The first Intelligent Endpoint System 102a has stored thereon Model 1 and Model 2. The second Intelligent Endpoint System 102b has stored thereon Model 1 and Model 2. The third Intelligent Endpoint System 102c has stored thereon Model 2 and Model 3. The fourth Intelligent Endpoint System 102d has stored thereon Model 1.

The first Intelligent Endpoint System 102a detects, generates, obtains, etc. data affects Model 2 (block 1001). At block 1002, the first Intelligent Endpoint System 102a then identifies other Intelligent Endpoint Systems that have Model 2 stored thereon. At block 1003, it propagates the data (or the updates to Model 2) to the other Intelligent Endpoint Systems with Model 2. Accordingly, the second and the third Intelligent Endpoint Systems 102b, 102c receive the propagation from the first Intelligent Endpoint System and they each respectively update Model 2 on their own hardware systems (blocks 1004, 1005).

In other words, the Intelligent Endpoint Systems can store different models and operate different models simultaneously. They can send relevant updates amongst each other, if they share the same model.

Turning to FIG. 10B, in a similar context as FIG. 10A, the first Intelligent Endpoint System 102a executes operations 1001, 1002. At block 1006, the first Intelligent Endpoint System then determine which other Intelligent Endpoint Systems with Model 2 are affected by the data. In other words, there could be other Intelligent Endpoint Systems that have stored thereon Model 2, but would not be affected by the data obtained or detected or generated by the first Intelligent Endpoint System 102a.

In this example, first Intelligent Endpoint System 102a determines that only the second Intelligent Endpoint System 102b is affected by the data.

At block 1007, the first Intelligent Endpoint System 102a sends the data or sends an updated Model 2, or both, to the second Intelligent Endpoint System 102b. Accordingly, the second Intelligent Endpoint System 102b updates its copy of Model 2 (block 1004). This helps to reduce data transfers amongst the IES devices.

In another example embodiment of how the Intelligent Endpoint Systems interact with each other, a voting or consensus or governance approach is used to determine whether an action should be performed. For example, if enough neighboring Intelligent Endpoint Systems get the same results (e.g. a number of Intelligent Endpoint Systems greater than a threshold number), then a given Intelligent Endpoint System (or a collective of Intelligent Endpoint Systems) performs a given action or a given set of actions. In an example embodiment, a voting or consensus or governance system is provided that biases the interaction amongst the Intelligent Endpoint Systems. The Intelligent Endpoint Systems interacts with this voting or consensus or governance system. In an example aspect, this voting or consensus or governance system is a remote computer system, or is implemented (e.g. physically resides) in a distributed manner on the Intelligent Endpoint Systems, or a combination thereof.

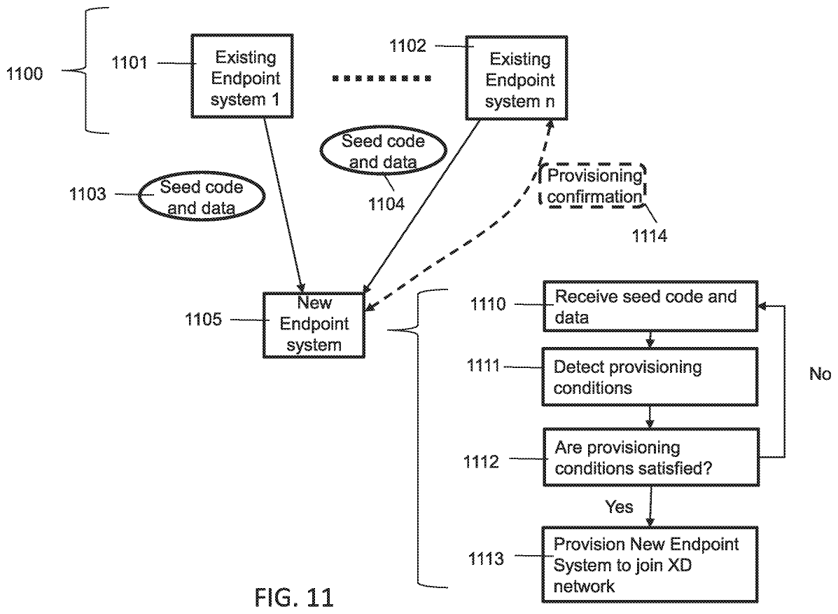

Turning to FIG. 11, an example embodiment is provided for provisioning Intelligent Endpoint Systems. An XD network of existing Intelligent Endpoint Systems 1100 include the Intelligent Endpoint Systems 1101, 1102. A potentially new Intelligent Endpoint System 1105, which potentially joins the network 1100, receives seed code and data 1103 from the first existing Intelligent Endpoint Systems 1101 and receives seed code and data 1104 from an nth existing Intelligent Endpoint System 1102.

At block 1110, the new Intelligent Endpoint System 1105 receives the seed code and data from the multiple existing Intelligent Endpoint Systems in the XD network 1100. At block 1111, the new Intelligent Endpoint System 1105 detects the one or more provisioning conditions provided in the seed code and the data. At block 1112, the new Intelligent Endpoint System 1105 determines if the one or more provisioning conditions are satisfied. This operation to make this determination could be made in combination with an existing Intelligent Endpoint System, for example, via a provisioning confirmation exchange 1114. If and after the one or more provisioning conditions are satisfied, then the new Intelligent Endpoint System 1105 is provisioned to join the XD network 1100.

In an example aspect, the provisioning process at block 1113 includes providing the new Intelligent Endpoint System 1105 with one or more of: known knowns, anomalies to look out for, actions, IDs related to the XD network 1100, models, data science, etc.

In another example aspect, the provisioning conditions include one or more of the following: the new Intelligent Endpoint System receiving at least X seeds of code and data from respective X existing Intelligent Endpoint Systems, where X is a natural number; the new Intelligent Endpoint System receives the seeds of code and data from existing Intelligent Endpoint Systems within a certain threshold distance relative to the new Intelligent Endpoint System; the new Intelligent Endpoint System receives the seeds of code and data from existing Intelligent Endpoint Systems that have at least a certain rating; the new Intelligent Endpoint System receives the seeds of code and data from existing Intelligent Endpoint Systems that are of a certain device type; and the new Intelligent Endpoint System satisfies or successfully completes tests that are provided in the seed code and data (e.g. computation speed test, memory capacity test, data transmission test such as for bandwidth or speed, etc.).

It will be appreciated that the example in FIG. 11 is one embodiment, and that there are other approaches to provisioning Intelligent Endpoint Systems.

In another example embodiment of provisioning, an Endpoint dispenser (e.g. such as the Endpoint dispenser 902) physically dispenses one or more Intelligent Endpoint Systems in order to perform the provisioning.

In an example embodiment, the system of Intelligent Endpoint Systems or a centralized computing system, or both, provision one or more new Intelligent Endpoint Systems to replace existing Intelligent Endpoint Systems that are considered to be anomalies (e.g. including and not limited to compromised, damaged, misappropriated, functioning in an anomalous manner, etc.).

In an example embodiment, the system of Intelligent Endpoint Systems or a centralized computing system, or both, provision multiple new Intelligent Endpoint Systems when additional computing power, sensor capability, communication performance, memory capacity, or physical power, or a combination thereof is required. For example, this process of suddenly provisioning multiple Intelligent Endpoint Systems when needed is herein called bursting the Intelligent Endpoint Systems.

In an example embodiment, the system of Intelligent Endpoint Systems or a centralized computing system, or both, provision multiple new Intelligent Endpoint Systems based on predicted future requirements. For example, an event is scheduled in the future, or an event is predicted to take place in the future, that would likely use more computing power, sensor capability, communication performance, memory capacity, or physical power, or a combination thereof. Therefore, in anticipation of such a prediction, multiple new Intelligent Endpoint Systems are provisioned. For example, a natural disaster is predicted to take place, and multiple new Intelligent Endpoint Systems are automatically provisioned to accommodate the predicted additional computing, sensing, memory and communication to be performed in relation to the natural disaster. The Intelligent Endpoint Systems are inserted at or near a location (e.g. physical or digital locations, or both) where the predicted event will take place.

In another example embodiment of processing data on Intelligent Endpoint Systems, each Intelligent Endpoint Systems has soft data and hard data. It will be appreciated that data in general includes, but is not limited to data, algorithms, data science, code, etc. Hard data in this example herein refers to data that is not often used by the Intelligent Endpoint System (e.g. used less than a given threshold frequency). Soft data is data that is often used by the Intelligent Endpoint System (e.g. used more than a given threshold frequency). Within the set of soft data, there is native soft data and visiting soft data. Native soft data originates from a given Intelligent Endpoint System, or is specific to the Intelligent Endpoint System. Visiting soft data is soft data that is on the given Intelligent Endpoint System, but originates from another device, or is for another device.

In an example aspect of this hard data and soft data embodiment, if the given Intelligent Endpoint Systems receives a signal or command from another device (e.g. another Intelligent Endpoint System or some other computing device) to do more processing, and the given Intelligent Endpoint Systems required more data space, then the given Intelligent Endpoint System compresses the hard data and then sends the hard data away to an off-site memory storage system or device. In another example aspect, the given Intelligent Endpoint System converts the soft data and to hard data, compresses it, and then sends it to an off-site memory storage system or device.

In another example aspect of this hard data and soft data embodiment, if the Intelligent Endpoint System receives a signal that more native soft data is coming, or will be generated, or will be required, then the given Intelligent Endpoint System discards the visiting soft data. The discarding of the visiting soft data is also a signal to other Intelligent Endpoint Systems to do the same.

In another example aspect of this hard data and soft data embodiment, if the Intelligent Endpoint System receives a distress signal that the visiting soft data is potentially dangerous, then the Intelligent Endpoint System discards the visiting soft data. The discarding of the visiting soft data is also a signal to other Intelligent Endpoint Systems to discard their respective visiting soft data.

In another example embodiment, an Intelligent Endpoint System transmits test code and data to other devices (e.g. other Intelligent Endpoint Systems) to look for fertile devices (e.g. desirable computing devices). The test code and data are scripts that, when executed, determine if certain algorithms can be run and/or certain data can be stored. If there is a positive result transmitted from a fertile device back to the Intelligent Endpoint System, then the Intelligent Endpoint System sends real code and data to the found fertile device. In an example aspect, the found fertile device gives various resources to the Intelligent Endpoint System, including, but not limited to: data, communication bandwidth, data storage, processing power, access to other networks, etc. In an example aspect, after the Intelligent Endpoint System first finds a fertile device (e.g. a finding that is characterized as an anomaly), the Intelligent Endpoint System transmits messages to other Intelligent Endpoint Systems about the found fertile device so that these other Intelligent Endpoint Systems can utilize the found fertile device. In another example aspect, the Intelligent Endpoint System sends test code and data to an inhospitable device and, in response, receives a negative result from the found inhospitable device. In an example aspect, after the Intelligent Endpoint System first finds an inhospitable device (e.g. a finding that is characterized as an anomaly), the Intelligent Endpoint System transmits messages to other Intelligent Endpoint Systems about the found inhospitable device so that these other Intelligent Endpoint Systems can avoid interacting with the inhospitable device. The negative result in relation to the found inhospitable device includes, for example, data that identifies inhospitable features (e.g. insufficient memory capacity, insufficient processing power, insufficient security measures, insufficient communication performance, etc.). In a further example aspect, the Intelligent Endpoint System uses data science and machine learning to identify which of these inhospitable features may likely improve over time. If there are one or more inhospitable features that are classified to likely improve, then the Intelligent Endpoint System at a future time sends a second set of test code to the found inhospitable device to determine if it has changed to become a fertile device.

In another example embodiment, the Intelligent Endpoint Systems each adapts their processing, memory storage, actions, or combinations thereof, based on one or more of: current energy availability, predicted future energy availability, current energy consumption, and predicted energy consumption. In an example aspect, the energy (e.g. electrical power) of an Intelligent Endpoint System is renewable. In another example aspect, the energy of an Intelligent Endpoint System is transferrable. In a further example aspect, the energy is transferrable amongst Intelligent Endpoint Systems, so that one Intelligent Endpoint System can renew the energy supply of another Intelligent Endpoint System. In an example aspect, the energy is stored in a battery.

Turning to FIG. 12, an example architecture of a system of Intelligent Endpoint Systems is provided. A first set of Intelligent Endpoint Systems 1201 interact with each other and one or more environments to collect data, sense data, capture data, communicate data, process data, store data, etc. The Intelligent Endpoint Systems 1201, for example, interact with 3^{rd} parties 1202 (e.g. 3^{rd} party databases, 3^{rd} party devices, 3^{rd} party environments, 3^{rd} party platforms, etc.). In an example embodiment, the one or more 3^{rd} parties are Intelligent Third Party Endpoint Systems.

In another example aspect, the first set of Intelligent Endpoint Systems 1201 form a faceted database. A faceted database herein refers to multiple databases. In an example aspect, at least some of these databases are related to each other. For example, different subsets of the Intelligent Endpoint Systems 1201 are used in different environments or different applications, or both. In another example, different subsets of the Intelligent Endpoint Systems 1201 also have different functions or different capabilities, or both. These differences lead, for example, to developing different databases, which as a collective is herein called a faceted database. In an example aspect, there is commonality amongst the databases in the faceted database, including, but not limited to, one or more of the following commonalities: common index(es), common pattern(s), common thematic data, common type(s) of data, common topic(s) of data, common event(s) in the data, common action(s) in the data, etc.

The first set of Intelligent Endpoint Systems transmit data to a load balancer system 1203 (e.g. which comprises one or more load balancing devices). The load balancer system then transmits the data to one or multiple Intelligent Endpoint Systems 1204, which are part of a second set. This second set of Intelligent Endpoint Systems 1204 are also herein called Intelligent Synthesizer Endpoint Systems.

In an example embodiment, the second set of Intelligent Endpoint Systems 1204 form a master database. In another example embodiment, either in addition or in alternative, the second set of Intelligent Endpoint Systems execute computations to process the received data using additional data science. The second set of Intelligent Endpoint Systems synthesize the data received from the first set of Intelligent Endpoint Systems by applying STRIPA. In other words, the second set of Intelligent Endpoint Systems act as a centralized computing resource on behalf of the first set of Intelligent Endpoint Systems, even though the second set is actually a collective of separate and distributed devices.

The master database residing on the second set of Intelligent Endpoint Systems 1204 can be referenced or queried by one or more Intelligent Endpoint Systems 1201 from the first set. Conversely, one or more of the Intelligent Endpoint Systems 1204 in the second set can query one or more of the databases that form part of the faceted database, which is stored in the first set.

In an example aspect, the faceted database that resides on the first set of Intelligent Endpoint Systems includes one or more blockchains or one or more immutable ledgers. In another example aspect, the master database that resides on the second set of Intelligent Endpoint Systems includes a master blockchain or a master immutable ledger.

The load balancer 1203 manages the distribution of data, processing, and communication amongst the second set of Intelligent Endpoint Systems 1204. The load balancer also manages the distribution of data, processing and communication amongst the first set of Intelligent Endpoint Systems 1201.

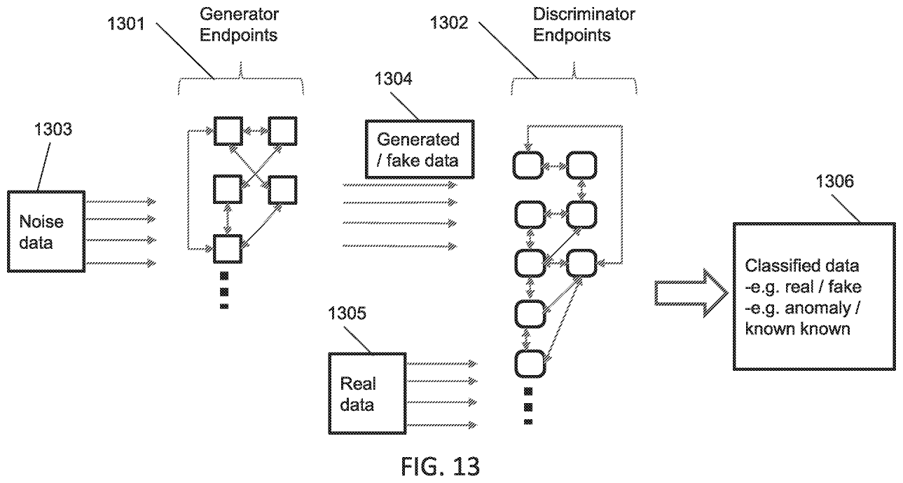

Turning to FIG. 13, another example embodiment of an architecture of Intelligent Endpoint Systems is provided. Different sets of Intelligent Endpoint Systems form different portions of a neural network system. The example shown in FIG. 13 relates to generative adversarial networks (GANs), which is used in artificial intelligence. A first set includes generator Intelligent Endpoint Systems 1301 and a second set includes discriminator Intelligent Endpoint Systems 1302. The generator Intelligent Endpoint Systems 1301 store and run a generator neural network in a distributed manner. The discriminator Intelligent Endpoint Systems 1302 store and run a discriminator neural network in a distributed manner.

In particular, the generator Intelligent Endpoint Systems 1301 obtain, sense or capture noise data 1303 and use this noise data to compute generated data or fake data 1304. The discriminator Intelligent Endpoint Systems 1302 obtain, sense or capture real data 1305. The discriminator Intelligent Endpoint Systems 1302 use the real data 1305 and the generated data 1304 to make classifications or predictions 1306 in relation to the obtained real data 1305. For example, the classifications or predictions include determining whether something is real or fake. In another example, the classifications or predictions include determine whether an anomaly has been detected or predicted, or whether a known known has been detected or predicted.

In other neural network computing systems, not limited to GANs, different portions of the neural networks are implemented by different sets of Intelligent Endpoint Systems.

In some example embodiments, the at least one of the plurality of Intelligent Endpoint Systems can be configured to autonomously update a local data store, data science, graph database, immutable ledger or blockchain (or both), index, memory, or app, to include the local data and or non-local data store, applications, systems, and third-party systems, and optionally to take a corresponding autonomous decisions and/or autonomous action if the query results from at least another one of the plurality of Intelligent Endpoint Systems responds with answers indicating the data is known or unknown. In some embodiments, the corresponding action is in response to an evaluation of the local data and/or one or more non-local data stores, applications, systems, immutable ledgers or blockchains (or both) and third-party systems. In some embodiments, the evaluation of the local data may be determined in response to an application selected from the group consisting of business rules, data science, computing requirements, and workflow actions applied to the local data and/or non-local data stores, immutable ledgers or blockchains (or both), applications, systems, and third-party systems.

In some example embodiments, some or all of the aforementioned Intelligent Endpoint System embodiments can be configured to use immutable technologies (such as, but not limited to, blockchains), which involve anonymous, immutable and encrypted ledgers and records that span over N number of Intelligent Endpoint Systems. These distributed ledgers, which are distributed in over multiple Intelligent Endpoint Systems, can be in the form of blockchains or other types of currently-known and future-known immutability protocols. These immutable ledgers can reside in RAM, cache, solid state, and spinning disk drive stores. In an alternative embodiment, these aforementioned stores can span across an ecosystem of store devices involving technologies such as Memcached, Apache Ignite; graph databases such as Giraph, Titan, and Neo4j, and structure and unstructured data stores such as Hadoop, Oracle, MySQL, etc.

In some example embodiments, the compute related to the immutable technologies, which is intrinsically compute intensive, can span a plurality of Intelligent Endpoint Systems in order to distribute the computing intensity.

In an alternative example embodiment, these immutable Intelligent Endpoint Systems can be configured to autonomously update a local data store, data science, graph database, index, memory, or app, to include the local data and or non-local data store, applications, systems, other immutable ledgers, and third-party systems, and optionally to take a corresponding autonomous decisions and/or autonomous action if the query results from at least another one of the plurality of intelligent edge nodes (e.g. which can be an immutable intelligent edge node or not an immutable intelligent edge node) responds with answers indicating the data is known or unknown.

In an example embodiment, the Intelligent Endpoint Systems include one or more of: human-computer interfaces (e.g. including brain-computer interfaces), devices controlled by human-computing interfaces, sensors that provide data to human-computer interfaces, and devices in communication with human-computer interfaces.

In an example processing or manufacturing embodiment, the Intelligent Endpoint Systems include one or more of: devices that process or manufacture objects; devices that analyze the objects; devices that monitor the objects; devices that transport the objects; devices that store the objects; and devices that monitor, analyze, repair, install, remove, or destroy, or any combination thereof, any of the other aforementioned devices.

In an example aspect, the Intelligent Endpoint Systems are part of a manufacturing system. In another example aspect, the Intelligent Endpoint Systems are part of a processing system for human-consumable products (e.g. food, cosmetics, drugs, supplements, etc.).

In an example embodiment, the Intelligent Endpoint Systems further includes output capabilities, such as display capabilities (e.g. light projector, display screen, augmented reality projectors or devices, holographic projector, etc.) and audio output capabilities (e.g. audio speaker). In an example embodiment, an Intelligent Endpoint System includes one or more media projectors, one or more audio speakers, one or more microphones, and one or more cameras, with voice recognition capabilities and image recognition capabilities.

In another example embodiment, the XD ecosystem of Intelligent Endpoint Systems apply data science to limit the number of IES devices (example: the number of instances of distributed immutable ledgers distributed amongst n IES devices) that get updated because data science (e.g. STRIPA and machine learning) computations have determined and recommended that n IES devices each storing instances of the distributed immutable ledgers are sufficient to be trusted for a given use case.

It is herein recognized that the supply chain, manufacturing, and distribution of human consumed food and beverages requires faster, more transparent, and auditable records and reports in order to track, measure, and report when a food poisoning outbreak occurs. In a simplistic example, when a food or a drink has been confirmed for the possibility of causing food poisoning, an integrated and intelligent immutable based consumer application and enterprise ecosystem is provided that can quickly and reliably perform the following example features.

In an example embodiment, the XD ecosystem facilitates in real-time consumers to input their information in their computing device (e.g. an Intelligent Endpoint System). The inputted information relates to a specific food or beverage induced poisoning anonymously and securely via the Internet app. The process includes using one or more Intelligent Endpoint Systems to: a) capture personally identifiable information (PII) without disclosing to upstream users of data (autonomous or progressive PII disclosure); b) capture the store or restaurant where food purchased or consumed; c) capture the store or restaurant receipt; d) capture a photograph showing one or more of the food barcode and human readable information, manufacturer, lot and bin number, and manufacturing and processing date; e) apply data science (e.g. ML and STRIPA) as more related consumer data points arrives to make recommendations based on the aggregate consumer collected data; and transmitting anonymized data, recommendations, meta data, and pictures to upstream sources (examples of which are listed below).

In a further example embodiment, the XD ecosystem facilitates real time notification of store(s) or restaurant(s) of the food induced poisoning. This notification can trigger one or more of the following operations, which can occur on one or more other Intelligent Endpoint Systems: a) finding and pulling food or beverage from shelves matching manufacturer lot and bin number and manufacturing and processing dates; b) performing quality assurance (QA) tests and reports to determine if food induced poisoning originated at this location(s); c) report results from QA tests; d) apply data science (ML and STRIPA) as more related consumer data arrives to make recommendations based on the aforementioned consumer data; e) transmit anonymized data, recommendations, meta data, and pictures to upstream sources (below); and f) take action including cleaning equipment, shelves, etc. and notifying employees of strict food handling rules, regulations, and procedures. Aspects of these operations can be fully automated or semi-automated.

In a further example operation, the XD ecosystem facilitates real time notification of distributors of the food induced poisoning. This notification can trigger one or more of the following operations, which can occur on Intelligent Endpoint Systems: a) find, pull, and remove food or beverage from warehouses and trucks matching manufacturer lot and bin number and manufacturing and processing dates; b) perform QA tests and report to determine if food induced poisoning originated at this location(s); c) report results from QA tests; d) apply data science (ML and STRIPA) as more related consumer data arrives to make recommendations based on the aforementioned consumer data; e) transmit anonymized data, recommendations, meta data, and pictures to upstream sources (below); and f) take action including cleaning equipment, shelves, etc. and notifying employees of strict food handling rules, regulations, and procedures. Aspects of these operations can be fully automated or semi-automated.

In a further example operation, the XD ecosystem facilitates real time notification to manufacturer(s) and processor(s) of food or drink. This notification can trigger one or more of the following operations, which can occur on Intelligent Endpoint Systems: a) find, pull, and remove food or beverage inventory at the plant matching manufacturer lot and bin number and manufacturing and processing dates; b) stop and clean all equipment related to food or beverage that manufactured and processed food or drink matching manufacturer lot and bin numbers; c) find, pull, and remove all raw materials and supplies at the plant matching manufacturer lot and bin number and manufacturing and processing dates; d) perform QA tests and report to determine if food induced poisoning originated at this location(s); e) report results from QA tests; f) apply data science (ML and STRIPA) as more related consumer data arrives to make recommendations based on the aforementioned consumer data; g) transmit anonymized data, recommendations, meta data, and pictures to upstream sources (below); and h) take action including cleaning equipment, shelves, etc. and notifying employees of strict food handling rules, regulations, and procedures. Aspects of these operations can be fully automated or semi-automated.

In a further example operation, the XD ecosystem facilitates real time notification to raw material and suppliers. This notification can trigger one or more of the following operations, which can occur on Intelligent Endpoint Systems: a) find, pull, and remove raw materials and supplies from warehouses and trucks matching manufacturer lot and bin number and manufacturing and processing dates; b) stop and clean all equipment related to raw materials and supplies that manufactured and processed food or drink matching manufacturer lot and bin numbers; c) perform QA tests and report to determine if food induced poisoning originated at this location(s); d) report results from QA tests; e) apply data science (ML and STRIPA) as more related consumer data arrives to make recommendations based on the aforementioned consumer data; f) transmit anonymized data, recommendations, meta data, and pictures to upstream sources (below); and g) take action including cleaning equipment, shelves, etc. and notifying employees of strict food handling rules, regulations, and procedures. Aspects of these operations can be fully automated or semi-automated.

In a further example operation, the XD ecosystem facilitates real time notification to any other upstream raw material, suppliers, farms, ranches that grow, manufacture, and process raw materials, supplies and livestock. This notification can trigger one or more operations (similar to the above operations), which can occur on Intelligent Endpoint Systems.

While pharmaceutical manufacturing and distribution has stricter rules and regulations, the principles and operations of the above example food and beverage approach (with appropriate modifications to be in FDA pharma compliance) can be applied to the pharmaceutical industry. These devices, systems and processes can also be used in the supply chain and processing systems of other types of human-consumables, such as supplements, cosmetics, surgical supplies, medical supplies, implantable objects like an organ or a stent or the like, prosthetics, dental hardware, contacts, etc.

In an example embodiment, the XD ecosystem, preferably in real time, autonomously updates the ecosystem ledgers as new information is discovered, as tests performed, and as data science based reports and recommendations become available. For example, the Intelligent Endpoint Systems in the XD ecosystem transmits reports of the results from the initial start of the supply chain all the way to the consumer web portal where the consumers entered their information.

In an example of immutable ledgers on Intelligent Endpoint Systems, the memory stores an immutable ledger that is distributed on multiple Intelligent Endpoint Systems. In another example aspect, the local data obtained, captured, created, sensed by one or more Intelligent Endpoint Systems is biological-related data that is stored on the immutable ledger. In another example aspect, the local data obtained, captured, created, sensed by one or more Intelligent Endpoint Systems is manufacturing data that is stored on the immutable ledger. In another example aspect, the Intelligent Endpoint System is used in a processing system for human-consumables (e.g. food, drugs, supplements, cosmetics, surgical supplies, medical supplies, implantable objects like an organ or a stent or the like, prosthetics, dental hardware, contacts, etc.), and the local data of one or more Intelligent Endpoint System pertains to a given human-consumable and the local data is stored on the immutable ledger.

In another example aspect, the Intelligent Endpoint System is a satellite and the local data is satellite data that is stored on the immutable ledger. In an example aspect, the satellite data is sensed by one or more sensors on the satellite. In another example, the satellite data is communication data that has been received by the satellite, and the communication data is configured to be transmittable by a ground station or another satellite.

In another example embodiment, the Intelligent Endpoint System is a brain-computer interface (e.g. which is a type of human-computer interface). In an alternative example aspect, the communication device of the Intelligent Endpoint System receives data from and transmits data to a brain-computer interface. In particular, in the field of human-computer interfaces, it is recognized that brain signals, nerve signals, muscle signals, chemical signals, hormonal signals, etc. and other types of biological related data can be sensed by an Intelligent Endpoint System and acted upon by the same Intelligent Endpoint System, or some ancillary Intelligent Endpoint System. Examples of Intelligent Endpoint System that interact with a brain-computer interface of a given user include a robotic drone, a robotic prosthetic limb, a computing device with voice chat capabilities, muscle stimulating devices, and other brain-computer interfaces of other users. The biological related data or other data utilized by these devices are, for example, stored on an immutable ledger that is distributed over multiple other Intelligent Endpoint Systems.

In another example embodiment, the Intelligent Endpoint System is part of an electric power production plant, and the local data obtained, captured, created, generated or sensed by one or more Intelligent Endpoint Systems pertains to operation and performance of the electric power production plant. In a further example aspect, this local data is stored on the immutable ledger that is distributed amongst multiple Intelligent Endpoint Systems. This helps to provide secure and reliable control and operation of an electric power production plant. Examples of electric power production plants include nuclear power plants, hydroelectric power plant, coal power plants, solar power plants, and wind power plants. In a further aspect, a system of Intelligent Endpoint Systems collaborate in the control and operation of the electric power plant. Examples of these Intelligent Endpoint Systems include 1609 controllable valve actuators, transformers, cooling devices, fans, temperature sensors, electrical relay devices, radiation sensors, pressure sensors, camera devices, and current sensors.

In another example aspect, the Intelligent Endpoint System is part of a water treatment plant, and the local data obtained, captured, created, generated or sensed by one or more Intelligent Endpoint Systems pertains to operation and performance of the water treatment plant, and the local data is stored on the immutable ledger that is distributed amongst multiple Intelligent Endpoint Systems. This helps to provide secure and reliable control and operation of the water treatment process. For example, cities or municipalities have an extensive infrastructure network for water treatment. Water treatment herein includes one or more of the following operations: obtaining water for drinking, treating water for drinking, distributing the water for drinking, receiving waste water, treating the waste water, and releasing or dumping the treated waste water. In a further aspect, a system of Intelligent Endpoint Systems collaborate in the control and operation of the water treatment plant. Examples of these Intelligent Endpoint Systems include controllable valve actuators, pump devices, flow sensors, pressure sensors, chemical sensors, chemical dispenser devices, electrical relay devices, camera devices, and electrical current sensors.

Below are other general example embodiments of the Intelligent Endpoint Systems.

In a general example embodiment, a system is provided for managing vast amounts of data to provide distributed and autonomous decision based actions. The system includes multiple Intelligent Endpoint Systems that are in communication with each other. Each Intelligent Endpoint System includes: memory that stores data science algorithms and local data that is first created, captured or sensed by the each Intelligent Endpoint System; one or more processors that at least perform localized decision science using the data science algorithms to process the local data to determine whether or not the local data is a known known, and to discard the local data from the memory after identifying that it is the known known; and, a communication device that communicates with other Intelligent Endpoint Systems in relation to one or more of: the data science algorithms, the determining of whether or not the local data is the known known, and an anomalous result pertaining to the local data.

In an example aspect, the one or more processors of the each Intelligent Endpoint System convert the local data to microcode and the communication device transmits the microcode to the other Intelligent Endpoint Systems.

In another example aspect, the one or more processors of the each Intelligent Endpoint System convert the one or more data science algorithms to microcode and the communication device of the each Intelligent Endpoint System transmits the microcode to the other Intelligent Endpoint Systems.

In another example aspect, the memory or the one or more processors, or both, are flashable with one or more new data science algorithms.

In another example aspect, an immutable ledger is distributed in the memory amongst the multiple Intelligent Endpoint Systems. For example, the local data is biological-related data that is stored on the immutable ledger. For example, the local data is manufacturing data that is stored on the immutable ledger. For example, the system is part of a processing system for human-consumables, and the local data pertains to a given human-consumable and the local data is stored on the immutable ledger. For example, each one of the multiple Intelligent Endpoint Systems is a satellite and the local data is satellite data that is stored on the immutable ledger.

In another example aspect, at least one of the Intelligent Endpoint Systems is a brain-computer interface.

In another example aspect, the one or more processors comprises a neuromorphic chip.

In another example aspect, the each Intelligent Endpoint System further includes one or more sensors for collecting the local data and one or more actuators controllable by the one or more processors.

In another example aspect, the multiple Intelligent Endpoint Systems are components of an electric power production plant, and the local data pertains to operation and performance of the electric power production plant, and the local data is stored on the immutable ledger.

In another example aspect, the multiple Intelligent Endpoint Systems are components of a water treatment plant, and the local data pertains to operation and performance of the water treatment plant, and the local data is stored on the immutable ledger.

In another example aspect, the system stores a graph database, wherein: multiple nodes of the graph database respectively correspond to the multiple Intelligent Endpoint Systems; data stored on each of the nodes is physically stored on the respectively corresponding Intelligent Endpoint Systems; and edges of the graph database between the multiple nodes are reflect the data communication links between the respectively corresponding Intelligent Endpoint Systems.

In another example aspect, the system further includes an Endpoint dispenser that dispenses one or more new Intelligent Endpoint Systems. In a further example aspect, the Endpoint dispenser comprises a container that stores the one or more new Intelligent Endpoint Systems that are to be dispensed.

In another example aspect, the each Intelligent Endpoint System has dimensions of approximately 5 mm×5 mm or less.

In another example aspect, a first subset of the multiple Intelligent Endpoint Systems implement a first neural network; a second subset of the multiple Intelligent Endpoint Systems implement a second neural network; outputs from the first neural network are transmitted from the first subset to the second subset; and the second subset receives and uses the outputs as inputs to the second neural network. In a further example aspect, the first neural network is a generator neural network; the second neural network is a discriminator neural network; the second subset of the multiple Intelligent Endpoint Systems obtain, capture, or sense real data as additional inputs to the second neural network; and a combination of the first subset and the second subset of the multiple Intelligent Endpoint Systems implement a generative adversarial network.

In another example aspect, the multiple Intelligent Endpoint Systems are provisioned at one or more locations where the local data is first created, captured or sensed. In a further example aspect, the multiple Intelligent Endpoint Systems are provisioned by physically inserting or dispensing the multiple Intelligent Endpoint Systems at the one or more locations.

In another general example embodiment, a system for managing vast amounts of data to provide distributed and autonomous decision based actions on Intelligent Endpoint Systems, includes: a remote computer system configured to request local data from an Intelligent Endpoint System via a computer network, wherein the Intelligent Endpoint System is among the plurality of Intelligent Endpoint Systems connected to the computer network; and the Intelligent Endpoint System inserted at a point where the requested local data is first created or obtained, wherein the plurality of Intelligent Endpoint Systems are configured to perform localized data science related to the local data, prior to transmitting the requested local data to the remote computer system.

In another example aspect, the plurality of Intelligent Endpoint Systems are configured to create local data.

In another example aspect, the plurality of Intelligent Endpoint Systems comprise databases to store data science algorithms.

In another example aspect, the databases are configured to be updated via the computer network.

In another example aspect, the plurality of Intelligent Endpoint Systems further comprises a second Intelligent Endpoint System, and wherein the Intelligent Endpoint System is configured to ping or query the second Intelligent Endpoint System to obtain data or metadata associated with the requested local data.

In another example aspect, performing the localized data science comprises determining whether the local data is a known known or a duplicate.

In another example aspect, performing the localized data science further comprises discarding the known known local data before transmitting the data over the computer network.

It is appreciated that these computing and software architectures are for example. Other architectures can also be used to process XD in a distributed manner.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The process descriptions or blocks in the flowcharts presented herein may be understood to represent modules, segments, or portions of code or logic, which include one or more executable instructions for implementing specific logical functions or steps in the associated process. Alternative implementations are included within the scope of the present invention in which functions may be executed out of order from the order shown or described herein, including substantially concurrently or in reverse order, depending on the functionality involved, as would be understood by those reasonable skilled in the art after having become familiar with the teachings of the present invention. It will also be appreciated that steps may be added, deleted or modified according to the principles described herein.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

What is claimed is:

1. A system for managing vast amounts of data to provide distributed and autonomous decision based actions, the system comprising multiple Intelligent Endpoint Systems that are in communication with each other, each Intelligent Endpoint System comprising:
memory that stores data science algorithms and local data that is first created, captured or sensed by the each Intelligent Endpoint System;
one or more processors that at least perform localized decision science using the data science algorithms to process the local data to determine whether or not the local data is a known known, and to discard the local data from the memory after identifying that it is the known known; and,
a communication device that communicates with other Intelligent Endpoint Systems in relation to one or more of: the data science algorithms, the determining of whether or not the local data is the known known, and an anomalous result pertaining to the local data.

2. The system of claim 1 wherein the one or more processors of the each Intelligent Endpoint System convert the local data to microcode and the communication device transmits the microcode to the other Intelligent Endpoint Systems.

3. The system of claim 1 wherein the one or more processors of the each Intelligent Endpoint System convert the one or more data science algorithms to microcode and the communication device of the each Intelligent Endpoint System transmits the microcode to the other Intelligent Endpoint Systems.

4. The system of claim 1 wherein the memory or the one or more processors, or both, are flashable with one or more new data science algorithms.

5. The system of claim 1 wherein an immutable ledger is distributed in the memory amongst the multiple Intelligent Endpoint Systems.

6. The system of claim 5 wherein the local data is biological-related data or biometric data that is stored on the immutable ledger.

7. The system of claim 5 wherein the local data is manufacturing data that is stored on the immutable ledger.

8. The system of claim 5 is part of a processing system for human-consumables, and the local data pertains to a given human-consumable and the local data is stored on the immutable ledger.

9. The system of claim 5 wherein each one of the multiple Intelligent Endpoint Systems is a satellite and the local data is satellite data that is stored on the immutable ledger.

10. The system of claim 1 wherein at least one of the Intelligent Endpoint Systems is a brain-computer interface.

11. The system of claim 1 wherein the one or more processors comprises a neuromorphic chip.

12. The system of claim 1 wherein the each Intelligent Endpoint System further comprises one or more sensors for collecting the local data and one or more actuators controllable by the one or more processors.

13. The system of claim 1 wherein the multiple Intelligent Endpoint Systems are components of an electric power production plant, and the local data pertains to operation and performance of the electric power production plant.

14. The system of claim 1 wherein the multiple Intelligent Endpoint Systems are components of a water treatment plant, and the local data pertains to operation and performance of the water treatment plant.

15. The system of claim 1 is storing a graph database, wherein: multiple nodes of the graph database respectively correspond to the multiple Intelligent Endpoint Systems; data stored on each of the nodes is physically stored on the respectively corresponding Intelligent Endpoint Systems; and edges of the graph database between the multiple nodes reflect the data communication links between the respectively corresponding Intelligent Endpoint Systems.

16. The system of claim 1 further comprising an Endpoint dispenser that dispenses one or more new Intelligent Endpoint Systems.

17. The system of claim 16 wherein the Endpoint dispenser comprises a container that stores the one or more new Intelligent Endpoint Systems that are to be dispensed.

18. The system of claim 1 wherein the each Intelligent Endpoint System has dimensions of approximately 5 mm×5 mm or less.

19. The system of claim 1 wherein: a first subset of the multiple Intelligent Endpoint Systems implement a first neural network; a second subset of the multiple Intelligent Endpoint Systems implement a second neural network; outputs from the first neural network are transmitted from the first subset to the second subset; and the second subset receives and uses the outputs as inputs to the second neural network.

20. The system of claim 19 wherein the first neural network is a generator neural network; the second neural network is a discriminator neural network; the second subset of the multiple Intelligent Endpoint Systems obtain, capture, or sense real data as additional inputs to the second neural network; and a combination of the first subset and the second subset of the multiple Intelligent Endpoint Systems implement a generative adversarial network.

21. The system of claim 1 wherein the multiple Intelligent Endpoint Systems are provisioned at one or more locations where the local data is first created, captured or sensed.

22. The system of claim 21 wherein the multiple Intelligent Endpoint Systems are provisioned by physically inserting or dispensing the multiple Intelligent Endpoint Systems at the one or more locations.

23. The system of claim 21 wherein the one or more locations are digital locations.

24. A system for managing vast amounts of data to provide distributed and autonomous decision based actions on Intelligent Endpoint Systems, comprising:
a remote computer system configured to request local data from an Intelligent Endpoint System via a computer network, wherein the Intelligent Endpoint System is among the plurality of Intelligent Endpoint Systems connected to the computer network; and
the Intelligent Endpoint System inserted at a point where the requested local data is first created or obtained, wherein the plurality of Intelligent Endpoint Systems are configured to perform localized data science related to the local data, prior to transmitting the requested local data to the remote computer system.

25. The system of claim 24, wherein the plurality of Intelligent Endpoint Systems are configured to create local data.

26. The system of claim 24, wherein the plurality of Intelligent Endpoint Systems comprise databases to store data science algorithms.

27. The system of claim 26, wherein the databases are configured to be updated via the computer network.

28. The system of claim 24, wherein the plurality of Intelligent Endpoint Systems further comprises a second Intelligent Endpoint System, and wherein the Intelligent Endpoint System is configured to ping or query the second Intelligent Endpoint System to obtain data or metadata associated with the requested local data.

29. The system of claim 24, wherein performing the localized data science comprises determining whether the local data is a known known or a duplicate.

30. The system of claim 29, wherein performing the localized data science further comprises discarding the known known local data before transmitting the data over the computer network.
